(19) United States
(12) Patent Application Publication
(10) Pub. No.: US 2010/0274427 A1
(43) Pub. Date: Oct. 28, 2010

(54) CONTROL APPARATUS FOR HYBRID DRIVING APPARATUS

(75) Inventors: Hiroaki Ebuchi, Shizuoka-ken (JP); Hiromichi Kimura, Aichi-ken (JP); Masaki Mitsuyasu, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Aichi-ken (JP)

(21) Appl. No.: 12/809,862

(22) PCT Filed: Dec. 24, 2008
(86) PCT No.: PCT/JP2008/073465

§ 371 Date: Jun. 24, 2010

(30) Foreign Application Priority Data
Dec. 25, 2007 (JP) 2007 333091

(51) Int. Cl. B60W 10/10; B60W 20/00; G06F 19/00

(52) U.S. Cl. 701/22; 477/5

(57) ABSTRACT

A speed-change mode is changed from a stepless speed-change mode to a fixed speed-change mode while limiting or controlling the torque variation of an output member.

An ECU 100 performs speed-change control. In the speed-change control, if a request is provided to change the speed-change mode from the stepless speed-change mode to the fixed speed-change mode, the ECU 100 engages the clutch mechanism 350 after the rotational synchronization and the phase synchronization of the clutch mechanism 350. After engaging the clutch mechanism 350, the ECU 100 gradually reduces the output torque of a motor generator MG1 and gradually changes a reaction element from a sun gear 331 to a sun gear 341. At this time, the output torque of a motor generator MG2 is also gradually reduced. The output torque of the motor generator MG2 is corrected to limit or control a change in the output torque of a drive shaft 320, on the basis of the gear ratio between the rotational elements of a power dividing mechanism 300 and the reduction amount of the output torque of the motor generator MG1.

### TECHNICAL FIELD

The present invention relates to a control apparatus for a hybrid driving apparatus, which is equipped with an internal combustion engine and an electric motor as the power source of a vehicle.

### BACKGROUND ART

As this type of driving apparatus for a hybrid vehicle, the following apparatus has been suggested: a driving apparatus provided with such a brake that a power source, an output member, and a first motor generator are connected to a power transfer mechanism, which is provided with a plurality of pairs of differential mechanisms, and that the rotation of any of the rotational elements of the power transfer mechanism is selectively stopped, to thereby fix a ratio of the number of rotations between the power source and the output member in an overdrive state (e.g. refer to a patent document 1). According to the driving apparatus for the hybrid vehicle disclosed in the patent document 1 (hereinafter referred to as a “conventional technology”), the hybrid driving apparatus is constructed such that the plurality of differential mechanisms do not contribute to torque transmission among the power source, the first motor generator, and the output member, in the condition that the ratio of the number of rotations is continuously controlled. Thus, it is considered that the power transmission efficiency of the entire apparatus can be improved and that a power loss can be limited or controlled.

Moreover, there has been also suggested such a driving apparatus that the rotational speed of a first motor generator, engine torque, the torque of a second motor generator, and a hydraulic pressure acting on a brake as a friction engagement apparatus are mutually and cooperatively controlled and that at that time, the rotational speed of the first motor generator is brought close to a target rotational speed before increasing the torque capacity of the brake, thereby limiting or controlling a rotational change in an output shaft associated with the implementation of speed-change control or transmission control (e.g. refer to a patent document 2).
Patent Document 1: Japanese Patent Application Publication Laid Open No. 2004-345527
Patent Document 2: Japanese Patent Application Publication Laid Open No. 2005-9514

### DISCLOSURE OF INVENTION

### Subject To Be Solved By the Invention

During a speed-change period in which transition is made from a stepless or variable speed-change state to a fixed speed-change state, the output torque of the output member easily varies with the engagement of the brake and the rotational element of the power distribution mechanism. In the conventional technology, however, there is no description about the prevention of the torque variation during the speed-change period, and the torque variation is easily actualized as the deterioration of drivability or the like. On the other hand, even if it is tried to apply the technology disclosed in the patent document 2 to the aforementioned problem, generally, a brake hydraulic pressure does not always accurately indicate the torque capacity of the brake no matter how fit they are set in advance, and if the control of the torque capacity of the friction engagement apparatus of this type exists in the limit of the torque variation of the output member, it would be hard to exclude such a possibility that the torque variation occurs in the torque of the output member to the extent that it can be actualized as the deterioration of drivability. In other words, the conventional technology has such a technical problem that the torque variation of the output member is hardly limited or controlled at the time of transition from a stepless speed-change state mode to a fixed speed-change state mode.

In view of the aforementioned problems, it is therefore an object of the present invention to provide a control apparatus for a hybrid vehicle, which can limit or control the torque variation of the output member when the speed-change mode is changed from the stepless speed-change state mode to the fixed speed-change state mode.

### Means For Solving the Subject

The above object of the present invention can be achieved by a control apparatus for a hybrid driving apparatus installed in a vehicle, the hybrid driving apparatus provided with: an internal combustion engine; a first electric motor; an engaging device comprising first and second engagement elements which can engage with each other; a power dividing device comprising a plurality of rotational elements including a first rotational element connected to an output shaft of the internal combustion engine, a second rotational element connected to an output shaft of the first electric motor, a third rotational element connected to a drive shaft of the vehicle, and a fourth rotational element connected to the first engagement element, the rotational elements being adapted to mutually perform differential rotation; and a second electric motor whose output shaft is connected to the third rotational element, the first electric motor capable of controlling rotational speeds of the first and fourth rotational elements, the hybrid driving apparatus capable of realizing each of a stepless speed-change mode, which can continuously change a rotational speed ratio between the drive shaft and the output shaft of the internal combustion engine, and a fixed speed-change mode, which fixes the rotational speed ratio to a predetermined value, as a speed-change mode of the vehicle by that rotation of the first engagement element is stopped in such a state that the first engagement element and the second engagement element are engaged and by that the first engagement element and the second engagement element are separated and engaged, the control apparatus provided with: a first controlling device for controlling the engaging device such that the first engagement element and the second engagement element are engaged in a mutually rotational synchronization state, in response to a change request indicating that the speed-change mode is to be changed from the stepless speed-change mode to the fixed speed-change mode; a second controlling device for reducing output torque of the first electric motor to predetermined target torque in the state that the first engagement element and the second engagement element are engaged with each other; and a third controlling device for controlling the second electric motor such that variations in output torque of the drive shaft are limited or controlled in at least one portion of a reduction period in which output torque of the first electric motor is reduced.

The hybrid driving apparatus of the present invention is an apparatus (which may be referred to in various manners, such as a system, a mechanism, or a unit) adapted to transmit a driving force in a form of torque or the like. The driving force is outputted from the internal combustion engine, the first electric motor such as a motor or a motor generator, and the second electric motor such as a motor or a motor generator, to the drive shaft of the vehicle in the present invention, as occasion demands. The drive shaft of the vehicle in the present invention can conceptually adopt the following form: an axle, which can adopt a form such as a drive shaft or an axle shaft, directly or indirectly connected to drive wheels, as a preferred form; or a rotational shaft, which is connected to the axle through a differential gear apparatus (which may be referred to in various manners, such as a gear system, a gear mechanism, or a gear unit) or various decelerating apparatuses (which may be referred to in various manners, such as a deceleration system, a deceleration mechanism, or a deceleration unit), as occasion demands, and which can rotate in association with the axle. In other words, the vehicle of the present invention, driven by the hybrid driving apparatus of the present invention, is a so-called hybrid vehicle.

In the hybrid driving apparatus of the present invention, the distribution of the driving force among the plurality of driving force sources is determined in accordance with the structure, e.g. the physical, mechanical, mechanistic, or electrical structure of the power driving device. Here, the power dividing device is provided with the first to fourth rotational elements, which are adapted to perform at least mutual differential rotation, and the power dividing device can adopt a form of a complex or composite planetary gear (which may be referred to in various manners, such as a gear apparatus, a gear mechanism, a gear system, or a gear unit) or the like, as a preferred form. In addition, the “complex planetary gear” described here includes a plurality of planetary gears, each of which is provided with a sun gear, a carrier, and a ring gear, as the rotational elements, and it includes such a planetary gear (i.e. complex planetary gear) in which arbitrary elements or one part of rotational elements in each planetary gear are directly or indirectly connected to make an integral rotational element (or rotational element which can be treated as one body).

The hybrid driving apparatus of the present invention is provided with the engaging device, which can conceptually adopt the following form: a hydraulically-controlled engaging apparatus, including a hydraulic brake or various hydraulic clutches, such as an engaging type clutch like a dog clutch, and a wet multiplate clutch; an electromagnetically-controlled friction engaging apparatus, such as an electromagnetic clutch; or a mechanical friction engaging apparatus, such as a hand brake. The engaging device is provided with the first and second engagement elements which can engage with each other. The engaging device can include various driving apparatuses which can drive at least one of the engagement elements so that the engagement elements engage with each other, various detecting devices for detecting the physical states of the engagement elements, and the like, as occasion demands.

At this time, the second engagement element is fixed, physically, mechanically, mechanistically, or electrically, or directly or indirectly, as a preferred form. Alternatively, as opposed to these, the second engagement element can hold, grip, or sandwich (also included in the concept of engagement) the first engagement element and can stop the rotation of the first engagement element at least in the state that the second engagement element engages with the first engagement element, regardless of how many elements constitute the second engagement element.

Here, in the hybrid driving apparatus of the present invention, at least the stepless speed-change mode and the fixed speed-change mode can be realized as the speed-change mode of the vehicle. More specifically, in the state that the first and second engagement elements in the engaging apparatus are separated from each other, i.e. in the situation that the rotation of the second engagement element is not stopped at least by the first engagement element, the stepless speed-change mode is realized which can change the rotational speed ratio (i.e. speed-change ratio) between the drive shaft and the output shaft of the internal combustion such as a crankshaft, strictly, substantially, or continuously within a range defined physically, mechanically, mechanistically, or electrically in advance (including a stepwise aspect similar to being continuous in practice). At this time, by virtue of the rotational speed control of the first electric motor having a function as the rotational speed control mechanism, which can control the rotational speed of the first rotational element connected to the output shaft of the internal combustion and the rotational speed of the fourth rotational element connected to the first engagement element, for example, the operating point of the internal combustion (or one operation condition defined by the output torque and the combustion rotational speed (i.e. the rotational speed of the output shaft)) is arbitrarily selected, theoretically, substantially, or within some restriction, and the operating point of the internal combustion is controlled to an optimum fuel consumption operating point or the like at which a fuel consumption rate can be realistically minimal (maximal in terms of travel distance per unit fuel amount), theoretically, substantially, or within some restriction.

On the other hand, if the first and second engagement elements engage with each other and the rotation of the first engagement element is stopped (uniquely, if the rotation of the fourth rotational element of the power dividing device is stopped), as described above, then, the speed-change ratio is fixed to one value in which a so-called overdrive speed-change ratio can be adopted as a preferred aspect at which the combustion rotational speed is less than the rotational speed of the drive shaft. Thus the fixed speed-change mode is realized. At this time, as a preferred form, the rotational speeds of the single or plurality of first rotational elements, which are directly or indirectly connected to the output shaft of the internal combustion, are uniquely defined by the rotational speed of the third rotational element, which is directly or indirectly connected to the drive shaft of the vehicle and which rotates in balance with a road load, and by the fourth rotational element whose rotational speed is zero or can be regarded as zero, physically or substantially, as a preferred form.

Here, if the fixed speed-change mode is selected and realized as the speed-change mode, the rotation of the fourth rotational element of the power dividing device is stopped by a physical, mechanical, mechanistic, electrical, or magnetic force generated by the engaging device, and it can function as the reaction element which receives the reaction torque of the output torque of the internal combustion engine. At this time, if the aforementioned stepless speed-change mode is performed, the hybrid vehicle can travel even if the second rotational element is maintained as the reaction element in the fixed speed-change mode, in view of the fact that the second rotational element (uniquely regarded as the first electric motor) functions as the reaction element (i.e. functions as the reaction element, to thereby function as the rotational speed control mechanism); however, the fourth rotational element is selected as the reaction element in the fixed speed-change mode because it is no longer necessary to supply the driving force corresponding to the reaction torque from the first electric motor by setting the fourth rotational element to the reaction element, and also because the use efficiency of an energy resource (preferably, electricity) is improved in the entire hybrid driving apparatus.

In view of this, in a change period in which the speed-change mode is changed from the stepless speed-change mode to the fixed speed-change mode, there arises a need to transfer the torque from the second rotational element to the fourth rotational element; however, the reaction torque received by the second rotational element influences the output torque of the drive shaft. Thus, in order to limit or control the variations in the output torque of the drive shaft to the extent that the deterioration of drivability is not actualized at least in practice, it is necessary to transfer the reaction torque, smoothly and accurately.

Here, in particular, engagement torque between the first and second engagement elements in the engaging device is hardly recognized at least directly, regardless of whether a correlation with the control amount of the engaging device (e.g. a physical, electrical, or magnetic indicated value for driving at least one of the first and second engagement elements which constitute the engaging device, such as a hydraulic pressure, a voltage, an electric current, an electric power, a duty rate, or an excitation current) is obtained in advance, or whether some study is made with time. In particular, if the engaging device is constructed as various friction engaging devices, such as a hydraulic clutch and a hydraulic brake, they are hydraulically driven as a preferred form. If it is tried to variably control at least the engagement torque continuously, the control accuracy of the engagement torque influenced by a hydraulic response is remarkably easily reduced, in comparison with the control accuracy of the torque of the first electric motor, which can function as a so-called torque detecting device.

Therefore, in the change period from the stepless speed-change mode to the fixed speed-change mode, if the continuous control of the engagement torque between the first and second engagement elements is essential when the reaction torque is sequentially transferred, then, for example, the balance of the torque between the second rotational element and the fourth rotational element possibly varies, or the balance of the torque between the first rotational element and the fourth rotational element possibly varies, and the variations in the output torque of the drive shaft are possibly actualized at a practically no-negligible level. Such a problem can occur even if it is tried to mutually and cooperatively control the torque in the first and second electric motors and the engaging device, for example, by outputting correction torque on the positive side or negative side through the third rotational element from the second electric motor or the like, as long as the engagement torque of the engaging device is controlled in which the detection accuracy or estimation accuracy of the torque is hardly ensured.

Thus, according to the control apparatus for the hybrid driving apparatus of the present invention, in its operation, the first controlling device, which can adopt a form of various computer systems such as microcomputer apparatuses, various controllers, various processing units, such as an ECU (Electronic Control Unit), directly or indirectly controls the engaging device such that the first engagement element and the second engagement element are engaged with each other in the rotational synchronization state, in response to the change request indicating that the speed-change mode is to be changed from the stepless speed-change mode to the fixed speed-change mode (i.e. in this case, there may be provided various driving or controlling apparatuses for driving or controlling the engaging device out of the conceptual range of the engaging device).

Here, the “change request” conceptually includes a physical, mechanical, electric, or magnetic signal or the like generated by artificially operating various operating devices, such as a button, a lever, a knob, a switch, and an operation dial, in order that an operator who is in the vehicle, such as a driver, changes the speed-change mode from the stepless speed-change mode to the fixed speed-change mode, and it conceptually includes a signal or the like automatically generated under control by some control apparatus, controller, computer system or the like, in accordance with various operating conditions, environmental conditions, travel conditions, or the like of the vehicle, such as a vehicle speed, a load, a request output, and a vehicle travel history, regardless of such an artificial operation, as a preferred aspect. The expression “in response to the change request” conceptually includes that those signals are outputted directly or indirectly to the first controlling device as a control signal or a signal to be referred to, or that the first controlling device itself generates this type of control signal, or the like.

The “mutually rotational synchronization state” when the first and second engagement elements are engaged with each other includes such a state that their rotational speeds are equal to each other as a preferred form, and it conceptually includes such a state that a deviation in the rotational speed between the two does not actualize any trouble at least in practice. Such rotational synchronization between the first and second engagement elements may be constructed in any manner; however, the second engagement element has at least such construction that it stops the rotation of the first engagement element in the state that it is engaged with the first engagement element, and thus, the rotational speed is at least substantially zero or is low to the extent that it can be regarded as zero. Therefore, the rotational synchronization can be preferably performed by controlling the rotational speed of the first electric motor, for example, such that the rotational speed of the fourth rotational element is at least substantially zero or has a value that can be regarded as zero, or the like.

The first and second engagement elements are engaged with each other, by that at least one of the engagement elements strokes the other engagement element, which is an engagement target, and thus the engagement elements interlock with each other after the rotational synchronization between the first and second engagement elements, or by that the engagement force of at least one of the first and second engagement elements is increased to the extent that it can physically or substantially fix the first rotational element, or the like. In other words, as long as the engaging device can realize a control aspect of a so-called rotational synchronization engaging type in which the rotational synchronization is performed between the first and second engagement elements before the first and second engagement elements are engaged with each other, the rotational synchronization comes into existence, regardless of whether it is an indispensable condition caused by the physical, mechanical, mechanistic, electric, or magnetic structure or the like of the engaging device.

If the first and second engagement elements are engaged in the mutually rotational synchronization state, then, an influence of inertia torque on the variations in the output torque of the drive shaft is small enough to be ignored at least in practice, and it is ideally zero, wherein the inertia torque can be generated in accordance with the rotation of the output shaft of the first electric motor transmitted to the first engagement element through the second engagement element when the first and second engagement elements are engaged. This does not change, regardless of whether the engaging device has such a structure that the first and second engagement elements are engaged by interlocking with each other or such a structure that the first and second engagement elements are engaged with each other by the engagement torque which can continuously change (whose value is hardly estimated, as described above) in accordance with the aforementioned hydraulic pressure, electromagnetic force, or the like.

According to the control apparatus for the hybrid driving apparatus of the present invention, in its operation, the second controlling device, which can adopt a form of various computer systems such as microcomputer apparatuses, various controllers, various processing units, such as an ECU, reduces the output torque of the first electric motor to the predetermined target torque in the state that the first and second engagement elements are engaged with each other.

As described above, when the fixed speed-change mode is performed, the reaction element which carries the reaction torque in the hybrid driving apparatus can be changed from the second rotational element (i.e. uniquely, the first electric motor) to the fourth rotational element (i.e. uniquely, the engaging device). At this time, the target torque of the first electric motor is such a small value that there is no practical problem even if it is treated as zero (i.e. in this case, the first electric motor only performs so-called idling with the rotation of the second rotational element accompanied by the rotation of another rotational element with which the second rotation element has a mutually differentially rotatable relation) or substantially zero as a preferred form. This target value is not necessarily this type of relatively small value as long as there is no problem at least in practice and as long as the output torque of the first electric motor can be reduced to some extent. For example, the reaction torque may be shared by the second and fourth rotational elements, mutually and cooperatively. If, however, the speed-change ratio realized by the fixed speed-change mode is the aforementioned overdrive speed-change ratio or the like, which can be preferably selected in a case where the vehicle is in a predetermined high-speed, light-load state or the like (i.e. the aforementioned request is provided), then, the first electric motor becomes in a power-running state in order to function as the reaction element on a negative rotation side and outputs the driving force to the drive shaft in some cases. At this time, in the second electric motor, there arises a need to generate electricity in order to supply an electric power required for the power-running, and energy loss is easily actualized due to so-called power circulation which repeats energy transfer. In view of such circumstances and in view of low necessity to maintain the first electric motor in a drive state in the fixed speed-change mode in practice, the target torque may be zero as a preferred form.

Here, at the stage that the operation of the first controlling device is performed, the first and second engagement elements are already engaged, and the fourth rotational element is already physically stopped. Therefore, the amount of the reduction in the output torque of the first electric motor is transferred to the engaging device in a one-to-one manner as a preferred form, and the input/output of the torque through the engaging device does not cause input/output variation in the drive shaft to the extent that there can be some trouble in practice. On the other hand, since there is a physical, mechanical, or mechanic difference between the second and the fourth rotational elements, such as a difference in a gear ratio and a difference in physical distance between the drive shaft and the second and fourth rotational elements, the proper output variation is generated in the drive shaft in accordance with the reduction amount of the output torque of the first electric motor in the process that the reaction element is transferred from the second rotational element (i.e. uniquely, the first electric motor) to the fourth rotational element (i.e. uniquely, the engaging device) (i.e. in the process that the output torque of the first electric motor is reduced). Moreover, in the aforementioned power circulation state, if the output torque of the first electric motor is reduced, then, the output torque of the second electric motor, which operates (i.e. which operates as a type of brake) on the electricity generation side in order to drive the first electric motor, becomes relatively excessive, thereby changing the output torque of the drive shaft.

Here, according to the control apparatus for the hybrid driving apparatus of the present invention, in its operation, the third controlling device, which can adopt a form of various computer systems, such as microcomputer apparatuses, various controllers, various processing units, such as an ECU, controls the second electric motor such that the variations in the output torque of the drive shaft are limited or controlled in at least one portion of the reduction period in which the output torque of the first electric motor is reduced. In other words, the output torque of the second electric motor is controlled to be increased or reduced (preferably to be reduced) variably, in a binary, stepwise, or continuous manner. As a result, the variations in the output torque of the drive shaft, which are generated in accordance with the degree of sharing the reaction torque with respect to the engaging device (i.e. uniquely, the degree of the reduction in the output torque of the first electric motor), are limited or controlled to some extent, at least in comparison with a case where this type of control is not performed at all. Incidentally, the expression “in at least one portion of the reduction period” indicates, in effect, that it is not always necessary to adjust the output torque of the second electric motor in the entire reduction period as long as it is judged that the reduction in the output torque of the first electric motor does not cause the variations in the output torque of the drive shaft to the extent that there can be some trouble in practice.

As described above, according to the control apparatus for the hybrid driving apparatus of the present invention, the engagement of the first and second engagement elements is already ended at a time point at which the variations in the output torque of the drive shaft can be generated (i.e. preferably, at a start time point of the reduction period) in a period in which the speed-change mode is changed from the stepless speed-change mode to the fixed speed-change mode (hereinafter referred to as a “change period” as occasion demands, wherein the change period conceptually includes the aforementioned “reduction period” of the present invention). Therefore, for example, regardless of whether the engaging device is constructed as an interlock engaging apparatus or a friction engaging apparatus, the engagement state of the engaging device (e.g. an engaging hydraulic pressure or the like) whose control accuracy is lower than those of the first and second electric motors does not influence the variations in the output torque which can be generated in the drive shaft. Moreover, regardless of whether the output torque of the second electric motor is feed-forward-controlled on the basis of a pre determined appropriate value in the change period, or it is feedback-controlled in accordance with the degree of the reduction in the output torque of the first electric motor, or it is controlled in real time in a one-to-one, one-to-many, many-to-one, or many-to-many manner in accordance with the degree of the reduction in the output torque of the first electric motor, it is possible to limit or control the variations in the output torque which can be generated in the drive shaft, more accurately than at least a case where the engagement state of the engaging device can influence the change in the output torque of the drive shaft, on the basis of only torque calculation in each of the rotational elements of the power dividing device (preferably, mainly, the second and third rotational elements). In other words, according to the control apparatus for the hybrid driving apparatus of the present invention, it is possible to limit or control the torque variation of the output shaft when the speed-change mode is changed from the stepless speed-change mode to the fixed speed-change mode.

In one aspect of the control apparatus for the hybrid driving apparatus of the present invention, the predetermined value of the rotational speed ratio is an overdrive speed-change ratio corresponding to that a combustion rotational speed of the internal combustion engine is less than a rotational speed of the drive shaft, and the target torque is zero.

The stepless speed-change mode can be selected without any problem in such an operating condition that there is no practical trouble caused by selecting the stepless speed-change, because the operating point of the internal combustion engine can be controlled to a practical optimum mileage operating point in an ideal, substantial, or some restriction range, as described above. For example, in so-called high-speed, light-load travelling in which the rotational speed of the drive shaft is high (whose judgment criterion about whether to be high or not can be set as occasion demands) and in which the rotational speed of the internal combustion engine is low (whose judgment criterion about whether to be low or not can be set as occasion demands), inevitably, the aforementioned power circulation is easily generated, and energy efficiency as the entire hybrid driving mechanism is easily reduced.

Therefore, if the fixed speed-change ratio realized by the fixed speed-change mode is the overdrive speed-change ratio and if the target torque of the first electric motor is zero, it is remarkably effective in that the high-speed, light-load travelling can be realized without any power loss by the power circulation.

In another aspect of the control apparatus for the hybrid driving apparatus of the present invention, the third controlling device controls the second electric motor in accordance with degree of the reduction in the output torque of the first electric motor.

The variations in the output torque generated in the drive shaft at the time of the aforementioned operations of the first and second controlling device of the present invention at least correlate with the degree of the reduction in the output torque of the first electric motor as a concept which can adopt such an aspect as a reduction amount, a reduction ratio, and a reduction speed, as a preferred form, no matter what value the speed-change ratio of the fixed speed-change mode has, and no matter what the physical relation among the rotational elements which constitute the power dividing device is like. The variations in the output torque in the drive shaft can be limited or controlled more accurately, by that the output torque of the second electric motor is controlled by the second controlling device in accordance with the degree of the reduction, which is recognized highly accurately enough not to cause any problem at least in practice. At this time, the control accuracy of the output torque of the second electric motor is desirably ensured, at least equally to or more than equally to the control accuracy of the first electric motor.

Incidentally, the control amount of the second electric motor according to the degree of the reduction in the output torque of the first electric motor may be mapped in advance thereby to selectively obtain one value, as occasion demands, or it may be obtained as a result of various arithmetic processes according to various algorithms and calculation formulas, which are set to calculate or derive the control amount of the second electric motor, such that the variations in the output torque of the drive shaft are not actualized to the extent that there is some trouble at least in practice, on the basis of experiments, experiences, theories, simulations, or the like, in advance at each time.

Incidentally, the “control amount” conceptually includes a value that defines the output torque of the second electric motor to be used to limit or control the variations in the output torque of the drive shaft. For example, it may be the output torque of the second electric motor (i.e. a target value), or an electric value, a voltage value, an electric current value, or the like corresponding to the output torque. Alternatively, it may be a correction amount to be used for various correction operations including, as occasion demands, addition, subtraction, multiplication, division, and the like with respect to the output torque of the second electric motor, which is one or a plurality of samples before.

Incidentally, in this aspect, it may be further provided with a calculating device for calculating a control amount of the second electric motor in the at least one portion of the reduction period on the basis of the degree of the reduction in the output torque of the first electric motor and a gear ratio among the first, second, third, and fourth rotational elements in the power dividing device, the third controlling device controls the second electric motor in accordance with the calculated control amount.

According to this aspect, the control amount of the second electric motor is calculated by the calculating device, which can adopt a form of various computer systems such as microcomputer apparatuses, various controllers, various processing units, such as an ECU, and the output torque of the second electric motor is controlled in accordance with the calculated control amount. At this time, the control amount is calculated on the basis of the degree of the reduction in the output torque of the first electric motor and the gear ratio among the first to fourth rotational elements in the power dividing device. Incidentally, for example, the “calculation” conceptually includes not only a process with a numeric operation or logical operation but also the selective obtainment of one or many values from various maps, as described above.

When the reaction torque carried by the second rotational element is transferred to the fourth rotational element, there can be the variations in the output torque of the drive shaft in accordance with the gear ratio among the first to fourth engagement elements (i.e. a ratio in the number of teeth). Therefore, it is possible to accurately limit or control the variations in the output torque of the drive shaft by calculating the control amount for limiting or controlling the variations in the output torque of the drive shaft on the basis of the degree of the reduction in the output torque of the first electric motor and the gear ratio.

In another aspect of the control apparatus for the hybrid driving apparatus of the present invention, the first and second engagement elements are engaged by interlocking with each other, and the second controlling device controls the first electric motor such that the degree of the reduction in the output torque of the first electric motor is small with respect to at least one portion excluding a beginning at the beginning of the reduction period.

According to this aspect, the engaging device is constructed as an interlock engaging apparatus in which the engagement elements are engaged by that some physical engagement parts (e.g. projections such as dog teeth, or various concavo-convex parts, or the like) formed in each of the engagement elements, such as a dog clutch, interlock with each other. This type of interlock engaging apparatus is an engaging device of a so-called rotational synchronization engaging type in which the aforementioned rotational synchronization between the engagement elements is essential in the engagement, as opposed to an engaging apparatus of a friction engagement type in which the engagement elements are engaged by various friction forces acting on the engagement elements. Although the control can be complicated in that it may further need phase control among the rotational elements according to circumstances, the interlock engaging apparatus easily obtains a larger engagement force than that in the friction engaging apparatus, and it is preferable as the reaction element in the fixed speed-change mode.

On the other hand, in this type of interlock engaging apparatus, in many cases, there is a gap between the engagement parts which are adjacent to each other in a rotation direction even in the state that interlock parts formed in each of the engagement elements interlock with each other, for example, in order to facilitate an interlock operation, or in order to correct or compensate the dimensional tolerance and dimensional accuracy of each of the engagement elements. Therefore, in the process that the output torque of the first electric motor is reduced and that the reaction torque is transferred to the engaging device, physical impact referred to as so-called “chatter or rattle” easily occurs. This type of physical impact basically causes the deterioration of drivability of the vehicle to a greater or lesser extent.

According to this aspect, the degree of the reduction in the output torque of the first electric motor is made relatively small at the beginning of the reduction period (which is equivalent to the aforementioned change period). Thus, the degree of the physical impact described above is reduced, thereby to limit or control the adverse effect on the drivability. Moreover, with regard to the at least one portion of the reduction period excluding the beginning, i.e. the remaining period excluding the beginning as a preferred form, the degree of the reduction is relatively increased, and the inefficient use of an energy resource caused by the lengthened reduction period is limited or controlled. In other words, according to this aspect, there is provided such a practically high benefit that the speed-change mode can be changed from the stepless speed-change mode to the fixed speed-change mode as quickly as possible while facilitating the transfer of the reaction torque to the engaging device as much as possible.

The operation and other advantages of the present invention will become more apparent from the embodiments explained below.

### BRIEF DESCRIPTION OF DRAWINGS

FIG. 1 is a schematic configuration diagram conceptually showing the structure of a hybrid vehicle in a first embodiment of the present invention.

FIG. 2 is a schematic diagram showing an engine in the hybrid vehicle in FIG. 1.

FIG. 3 is a schematic configuration diagram conceptually showing the structure of a power dividing mechanism in the hybrid vehicle in FIG. 1.

FIG. 4 is a nomogram corresponding to each speed-change mode realized in the power dividing mechanism in FIG. 3.

FIG. 5 is a flowchart showing speed-change control performed by an ECU in the hybrid vehicle in FIG. 1.

FIG. 6 is a flowchart showing a clutch engaging process branching from the speed-change control in FIG. 5.

FIG. 7 are nomograms of the power dividing mechanism in the course of the clutch engaging process in FIG. 6.

FIG. 8 is a time chart showing torque in each element in the course of the clutch engaging process in FIG. 6.

FIG. 9 is a time chart showing torque in each element in the course of a clutch engaging process in a comparative example to be used for comparison with the embodiment.

FIG. 10 is a flowchart showing a clutch release process branching from the transmission control in FIG. 5.

FIG. 11 is a schematic configuration diagram conceptually showing one example of the power dividing mechanism in a second embodiment of the present invention.

FIG. 12 is a schematic configuration diagram conceptually showing another example of the power dividing mechanism in the second embodiment of the present invention.

### DESCRIPTION OF REFERENCE CODES

10 hybrid vehicle
100 ECU
200 engine
202 cylinder
203 piston
205 crankshaft
300 power dividing mechanism
MG1 motor generator
MG2 motor generator
310 input shaft
320 drive shaft
331 sun gear
332 carrier
333 ring gear
341 sun gear
342 carrier
343 ring gear
350 clutch mechanism
351 clutch plate
352 clutch plate
600 vehicle speed sensor
700 priority switch
800 power dividing mechanism (third embodiment)
900 power dividing mechanism (third embodiment)

### BEST MODE FOR CARRYING OUT THE INVENTION

### Embodiments of the Invention

Hereinafter, various preferred embodiments of the present invention will be explained with reference to the drawings.

### First Embodiment

### Structure of Embodiment

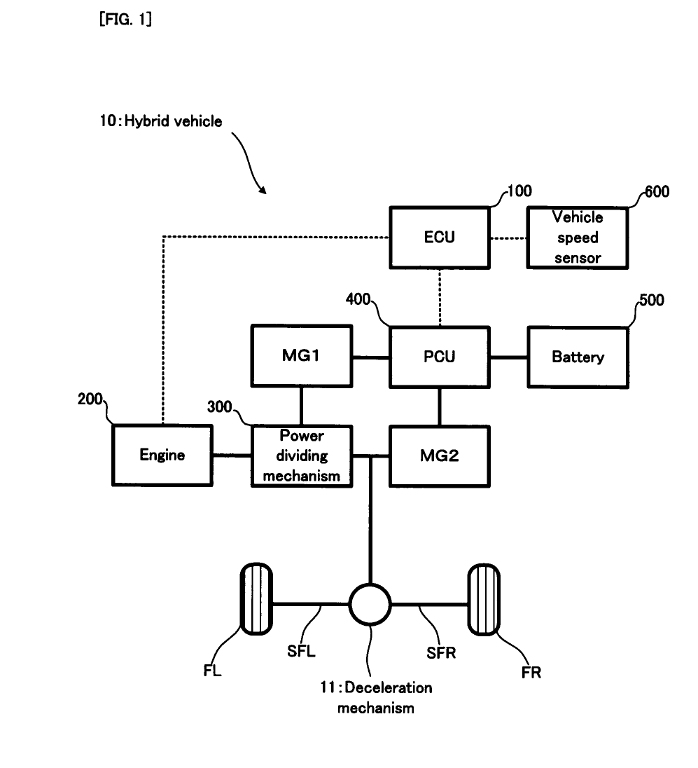

Firstly, with reference to FIG. 1, an explanation will be given on the structure of a hybrid vehicle 10 in a first embodiment of the present invention. FIG. 1 is a schematic configuration diagram conceptually showing the structure of the hybrid vehicle 10.

In FIG. 1, the hybrid vehicle 10 is provided with an ECU 100; an engine 200; a power dividing mechanism 300; a motor generator MG1 (hereinafter abbreviated to a “MG1”, as occasion demands); a motor generator MG2 (hereinafter abbreviated to a “MG2”, as occasion demands); a PCU (Power Control Unit) 400; a battery 500; and a vehicle speed sensor 600. The hybrid vehicle 10 is one example of the “vehicle” of the present invention.

The ECU 100 is provided with a CPU (Central Processing unit), a ROM (Read Only Memory), a RAM, and the like. The ECU 100 is an electronic control unit, adapted to control the entire operation of the hybrid vehicle 10, and it is one example of the “control apparatus for the hybrid driving apparatus” of the present invention. The ECU 100 can perform speed-change control or transmission control described later, in accordance with a control program stored in the ROM.

Incidentally, the ECU 100 is an integrated or one-body electronic control unit, adapted to function as one example of each of the “first controlling device”, the “second controlling device”, the “third controlling device”, and the “calculating device” of the present invention. The respective operations of the devices are all performed by the ECU 100; however, the physical, mechanical, and electrical configurations of each of the devices are not limited to this. For example, the devices may be constructed as various computer systems, such as microcomputer apparatuses, various controllers, various processing units, and a plurality of ECUs.

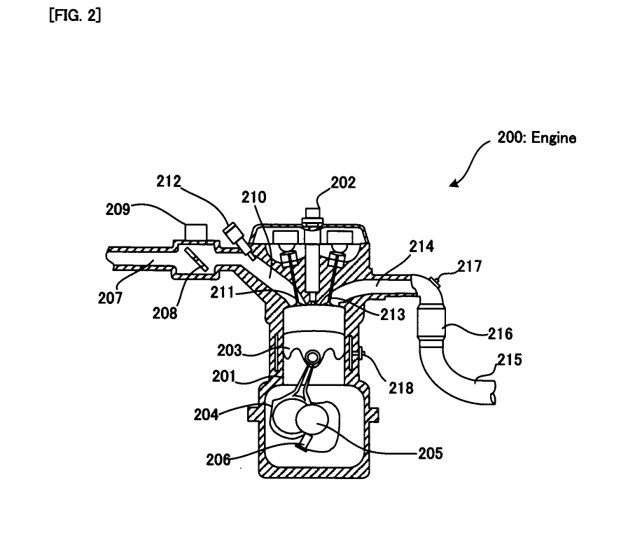

The engine 200 is a gasoline engine as one example of the “internal combustion engine” of the present invention, and it can function as the main power source of the hybrid vehicle 10. Now, with reference to FIG. 2, the detailed structure of the engine 200 will be explained. FIG. 2 is a schematic diagram showing the engine 200. Incidentally, in FIG. 2, the repeated points of FIG. 1 will carry the same reference numerals, and the explanation thereof will be omitted as occasion demands. Incidentally, the “internal combustion engine” of the present invention includes a two-cycle or four-cycle reciprocating engine or the like and has at least one cylinder. The “internal combustion engine” of the present invention conceptually includes a mechanism adapted to extract an explosive power, generated when an air-fuel mixture including various fuels, such as gasoline, light oil, or alcohol, combusts in a combustion chamber in the cylinder, as a driving force through a power transmitting device such as a piston, a connecting rod, and a crankshaft, as occasion demands. As long as such a concept is satisfied, the configuration of the internal combustion engine in the present invention is not limited to that of the engine 200, but may have various aspects.

In FIG. 2, the engine 200 enables the air-fuel mixture to be combusted through an ignition operation by an ignition apparatus 202 in which one portion of an ignition plug or spark plug (whose reference numeral is omitted) is exposed in the combustion chamber in the cylinder 201. The engine 200 can also convert the reciprocating motion of a piston 203, caused in accordance with the explosive power by the combustion, to the rotational motion of a crankshaft 205 (i.e. one example of the “combustion output shaft” of the present invention) through a connecting rod 204.

In the vicinity of the crankshaft 205, a crank position sensor 206 is placed, which detects the rotational position of the crankshaft 205 (i.e. a crank angle). The crank position sensor 206 is electrically connected to the ECU 100 (not illustrated), and the ECU 100 can calculate the combustion or engine rotational speed NE of the engine 200 on the basis of a crank angle signal outputted from the crank position sensor 206.

Incidentally, the engine 200 is an in-line four-cycle engine in which four cylinders 201 are aligned in a direction perpendicular to the paper. The structures of the individual cylinders 201 are equal to each other, so only one cylinder 201 will be explained in FIG. 2. The number of cylinders and the arrangement of each cylinder in the internal combustion engine in the present invention are not limited to those of the engine 200 but can adopt various aspects in the range satisfying the aforementioned concept: for example, an engine of a six-cylinder, eight-cylinder, or 12-cylinder type, or of a V-shaped type, of a horizontally-opposed type, or the like.

In the engine 200, the air sucked from the exterior is supplied through an intake tube 207 and an intake port 210 to the inside of the cylinder 201 in the opening of an intake valve 211. On the other hand, the fuel injection valve of an injector 212 is exposed in the intake port 210, and it is adapted to inject or spray the fuel to the intake port 210. The fuel injected or sprayed from the injector 212 is mixed with the intake air before or after the valve opening timing of the intake valve 211, to thereby make the aforementioned air-fuel mixture.

The fuel is stored in a not-illustrated fuel tank and is supplied to the injector 212 through a not-illustrated delivery pipe by the operation of a not-illustrated feed pump. The air-fuel mixture combusted in the cylinder 201 becomes an exhaust gas and is supplied to an exhaust tube 215 through an exhaust port 214 in the opening of an exhaust valve 213 which opens or closes in conjunction with the opening or closing of the intake valve 211.

On the other hand, on the upstream side of the intake port 210 in the intake tube 207, a throttle valve 208 is disposed, which adjusts an intake air amount associated with the intake air supplied through a not-illustrated cleaner. The throttle valve 208 is constructed such that the driving state thereof is controlled by a throttle valve motor 209, which is electrically connected to the ECU 100. Incidentally, the ECU 100 basically controls the throttle valve motor 209 to obtain a throttle opening degree according to the opening degree of an accelerator pedal not illustrated (hereinafter referred to as an “accelerator opening degree”, as occasion demands); however, it can also adjust the throttle opening degree without a driver's will through the operation control of the throttle valve motor 209. In other words, the throttle valve 208 is constructed as a kind of electronically-controlled throttle valve.

In the exhaust tube 215, a ternary or three-way catalyst 216 is placed. The ternary catalyst 216 is a catalyst apparatus adapted to purify each of CO (carbon monoxide), HC (hydrocarbon), and NOx (nitrogen oxide), emitted from the engine 200. Incidentally, in the engine 200, various catalysts, such as a NSR catalyst (or NOx storage-reduction catalyst) or an oxidation catalyst, may be placed, instead of or in addition to the ternary catalyst 216.

Moreover, in the exhaust tube 215, an air-fuel ratio sensor 217 is placed, which can detect the exhaust air-fuel ratio of the engine 200. Moreover, in a water jacket placed in a cylinder block for accommodating the cylinder 201, a water temperature sensor 218 is disposed in order to detect a coolant temperature associated with a coolant or cooling water (LLC) circulated and supplied to cool the engine 200. The air-fuel ratio sensor 217 and the temperature sensor 218 are electrically connected to the ECU 100, and the detected air-fuel ratio and the detected coolant temperature are grasped by the ECU 100 at a constant or inconstant detection frequency.

Back in FIG. 1, the motor generator MG1 is an electric motor generator as one example of the “first electric motor” of the present invention, adapted to mainly generate electricity for charging a battery 500 or for supplying electricity to the motor generator MG2 by being driven by torque from the engine 200 and being rotated. The motor generator MG1 can continuously change the combustion rotational speed NE of the engine 200 through the control of the rotational speed thereof. Such a stepless speed change function is due to the differential operation of the power dividing mechanism 300 described later. Incidentally, the motor generator MG1 can also function as an electric motor, depending on the travel state of the hybrid vehicle 10.

The motor generator MG2 is an electric motor generator as one example of the “second electric motor” of the present invention, adapted to function as an electric motor for assisting the power of the engine 200 or as an electric generator for charging the battery 500. More specifically, the motor generator MG2 is an apparatus for aiding (or assisting) a driving force or a braking force. If assisting the driving force, the motor generator MG2 is supplied with electricity and functions as the electric motor. If assisting the braking force, the motor generator MG2 is rotated by torque transmitted from the driving wheel side of the hybrid vehicle 10 and functions as the electric generator for generating electricity.

Incidentally, each of the motor generator MG1 and the motor generator MG2 is constructed as, for example, a synchronous electric motor generator, and it is provided with a rotor having a plurality of permanent magnets on the outer circumferential surface; and a stator having a three-phase coil for forming a rotating magnetic field; however, it may be another form of motor generator. The motor generator MG2 has such a structure that the output rotational shaft thereof is connected to a drive shaft 320 described later (i.e. one example of the “drive shaft” of the present invention) to allow the drive shaft 320 to be supplied with the power, wherein the drive shaft 320 is connected through a deceleration mechanism 11 including various reduction gear apparatuses, such as a differential, to drive shafts SFL and SFR, which are connected to a left front wheel FL and a right front wheel FR as the driving wheels of the hybrid vehicle 10, respectively. In other words, the rotational speed of the drive shaft 320 is uniquely or unambiguously related to the rotational speed Nmg2 of the motor generator MG2.

The PCU 400 includes an inverter or the like, which is adapted to convert a direct-current (DC) power extracted from the battery 500 to an alternating-current (AC) power and to supply it to the motor generators MG1 and MG2, and which is adapted to convert an AC power generated by the motor generators MG1 and MG2 to a DC power and to supply it to the battery 500. The PCU 400 is a control unit adapted to individually control the input/output of the power between the battery 500 and each motor generator. The PCU 400 is electrically connected to the ECU 100, and the PCU 400 is controlled by the ECU 100.

The battery 500 is a chargeable accumulator or storage battery, adapted to function as a power supply source associated with the power for power-running the motor generators MG1 and MG2.

A vehicle-speed sensor 600 can detect the vehicle speed V of the hybrid vehicle 10. The vehicle-speed sensor 600 is electrically connected to the ECU 100, and the detected vehicle speed V is grasped by the ECU 100 at a constant or inconstant frequency.

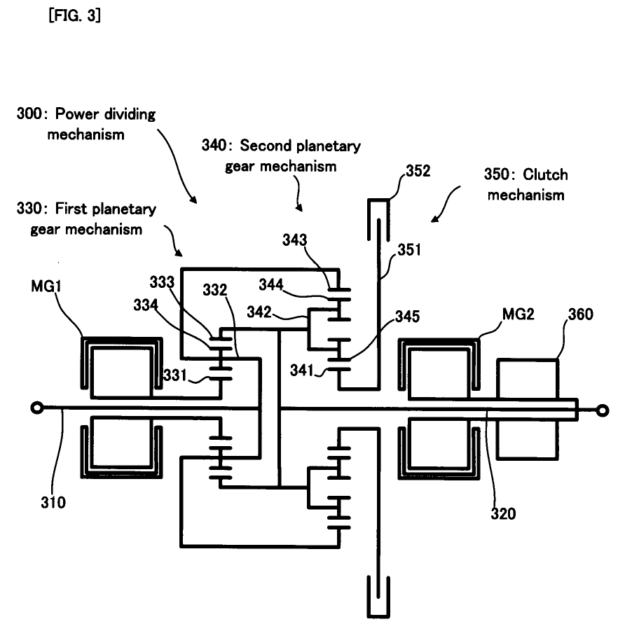

The power dividing mechanism 300 is a complex or composite planetary gear unit, as one example of the “power dividing device” of the present invention, adapted to physically control the input/output state of the power between the drive shaft 320 and each of the engine 200 and the motor generators MG1 and MG2. Now, with reference to FIG. 3, the detailed structure of the power dividing mechanism 300 will be explained. FIG. 3 is a schematic configuration diagram conceptually showing the structure of the power dividing mechanism 300. Incidentally, in FIG. 3 the repeated points of FIG. 1 will carry the same reference numerals, and the explanation thereof will be omitted as occasion demands.

In FIG. 3, the power dividing mechanism 300 can divide the output torque of the engine 200 (hereinafter referred to as “engine torque”, as occasion demands) into the motor generator MG1 and the drive shaft 320, and it is provided with a plurality of rotational elements which mutually cause the differential operation. More specifically, the power dividing mechanism 300 is provided with a plurality of pairs of differential mechanisms. An input shaft 310 is connected to the first rotational element of the three rotational elements which mutually cause the differential operation. The rotational shaft of the motor generator MG1 is connected to the second rotational element. The drive shaft 320 is connected to the third rotational element. The input shaft 310 is connected to the crankshaft 205 of the engine 200 described above, and the drive shaft 320 is connected to the rotational shaft of the motor generator MG2, as described above, and to a MG2 speed-changing part 360 described later. In other words, each of the engine 200 and the motor generators MG1 and MG2 is connected to the power dividing mechanism 300.

The power dividing mechanism 300 is formed as a so-called Ravigneaux planetary gear mechanism, provided with a first planetary gear mechanism 330 of a single pinion gear type; and a second planetary gear mechanism 340 of a double pinion type, as the differential mechanism.

The first planetary gear mechanism 330 is provided with a sun gear 331; a carrier 332; a ring gear 333; and a pinion gear 334, which engages or interlocks with the sun gear 331 and the ring gear 332 and which is held by the carrier 332 so as to rotate in an axial direction and to revolve because of the rotation of the carrier 332. The motor generator MG1 is connected to the sun gear 331. The input shaft 310 is connected to the carrier 332. The drive shaft 320 is connected to the ring gear 333.

The second planetary gear mechanism 340 is provided with a sun gear 341; a carrier 342; a ring gear 343; a pinion gear 344, which engages or interlocks with the ring gear 343; and a pinion gear 345, which engages or interlocks with the sun gear 331, wherein each of the pinion gears 344 and 345 is held by the carrier 342 so as to rotate in an axial direction and to revolve because of the rotation of the carrier 342. A clutch plate 351 of a clutch mechanism 350 described later is connected to the sun gear 341. The ring gear 333 of the first planetary gear mechanism 330 is connected to the carrier 342. The carrier 332 of the first planetary gear mechanism 330 is connected to the ring gear 343.

As described above, as a whole, the power dividing mechanism 300 is provided with the four rotational elements in total, which are the sun gear 331 of the first planetary gear mechanism 330; the sun gear 341 of the second planetary gear mechanism 340; the carrier 332 of the first planetary gear mechanism 330 and the ring gear 343 of the second planetary gear mechanism 340, which are mutually connected; and the ring gear 333 of the of the first planetary gear mechanism 330 and the carrier 342 of the second planetary gear mechanism 340, which are mutually connected. The sun gear 331 is one example of the “second rotational element” of the present invention. The sun gear 341 is one example of the “fourth rotational element” of the present invention. The carrier 332 and the ring gear 343 are one example of the “first rotational element” of the present invention. The ring gear 333 and the carrier 342 are one example of the “third rotational element” of the present invention.

The clutch mechanism 350 is an engaging apparatus of a rotational-synchronization engaging type as one example of the “engaging device” of the present invention, including a dog clutch. The clutch mechanism 350 has the clutch plate 351 and a clutch plate 352, and the clutch plates are engaged by interlocking with each other.

The clutch plate 351 is one example of the “first engagement element” of the present invention, wherein the clutch plate 351 is connected to the sun gear 341 of the second planetary gear mechanism 340, and the clutch plate 351 and the sun gear 341 can rotate in pairs. On the engagement surface of the clutch plate 351 facing the clutch plate 352, a plurality of dog teeth are formed, which make a physical unevenness part. Moreover, the clutch plate 352 is one example of the “second engagement element” of the present invention, wherein the clutch plate 352 is physically fixed to the case part of the power dividing mechanism 300. On the engagement surface of the clutch plate 352 facing the clutch plate 351, a plurality of dog teeth are formed, which are the same as the dog teeth of the clutch plate 351 and which can mutually engage or interlock with the dog teeth of the clutch plate 351. In the engagement of the clutch mechanism 350, the dog teeth formed on the clutch plate 351 and the dog teeth formed on the clutch plate 352 engage or interlock with each other. At this time, since the clutch plate 351 is physically fixed, the rotation of the clutch plates 351 and the rotation of the sun gear 341 connected to the clutch plates 351 are stopped, and the clutch 351 and the sun gear 341 also get physically fixed.

Incidentally, the clutch mechanism 350 is provided with a driving apparatus for driving the clutch plate 351 and a resolver for detecting the rotation angle of the clutch plate 351 (both of which are not illustrated), in addition to the illustrated clutch plates 351 and 352. The driving apparatus is a driving force applying device, adapted to apply a driving force for stroking the clutch plate 351 in its rotation direction and a direction of the clutch plate 352. The driving apparatus is electrically connected to the ECU 100, and the operation of the driving apparatus is superior-controlled by the ECU 100.

The resolver is an angle sensor, adapted to detect the rotation phase of the clutch plate 351. The resolver is electrically connected, and the detected rotation phase (or angle) of the clutch plate 351 is grasped by the ECU 100 at a constant or inconstant frequency.

Incidentally, the construction that the “engaging device” of the present invention can adopt is not limited to the clutch mechanism 350, but as long as it can adopt the rotational-synchronization engaging type, it may be another interlock type of engaging device, or various friction engaging apparatuses driven in accordance with a hydraulic pressure or electromagnetic force, or various engaging apparatuses having another physical, mechanical, or electric engagement aspect.

The power dividing mechanism 300 is also provided with the MG2 speed-changing part 360. The MG2 speed-changing part 360 is placed on a power transmission path between the rotational shaft of the motor generator MG2 and the drive shaft 320, and it is provided with a plurality of friction engaging apparatuses; and driving apparatuses, such as hydraulic actuators, for driving the respective friction engaging apparatuses. The MG2 speed-changing part 360 can change a rotational speed ratio between the rotational shaft of the motor generator MG2 and the drive shaft 320 in a stepwise manner, by the combination of contact states of the respective plurality of friction engaging apparatuses. The change gear ratio of the MG2 speed-changing part 360 is controlled accordingly by the ECU 100 through the control of the aforementioned driving apparatuses such that the motor generator MG2 does not exceed the maximum rotational speed and such that the motor generator MG2 rotates in as a highly efficient rotation area as possible.

As described above, the hybrid vehicle 10 is provided, as the driving apparatuses thereof, with the engine 200, the motor generator MG1, the motor generator MG2, and the power dividing mechanism 300. These are, namely, one example of the “hybrid driving mechanism” of the present invention.

### Operation of Embodiment

### Details of Speed-Change Mode

The power dividing mechanism 300 functions as the speed-changing apparatus or gearbox of the hybrid vehicle 10. At this time, in the power dividing mechanism 300, the following two types of speed-change modes are realized: a stepless speed-change mode and a fixed speed-change mode.

When the power dividing mechanism 300 drives the engine 200 in the condition that the corresponding rotational element (which is the sun gear 341 of the second planetary gear mechanism 340 in this case) is not fixed by the clutch mechanism 350, the engine torque is divided into and transmitted to the motor generator MG1 and the drive shaft 320, by the power dividing mechanism 300. This is due to the differential operation of the power dividing mechanism 300. By increasing or decreasing the rotational speed of the motor generator MG1, the combustion rotational speed NE of the engine 200 is controlled in a stepless (or continuous) manner. This is a stepless speed-change state (or variable speed state), and the speed-change mode corresponding to the stepless speed-change state is the stepless speed-change mode. In the stepless speed-change mode, only the first planetary gear mechanism 330 substantially contributes to the transmission of the engine torque to the drive shaft 320. The combustion rotational speed NE of the engine 200 in the stepless speed-change mode is controlled, with a value corresponding to an optimum fuel consumption operating point being set as a target rotational speed, such that the operating point of the engine 200 (an operational condition defined as a combination of the combustion rotational speed and a load (i.e. uniquely regarded as the engine torque) is the optimum fuel consumption operating point at which the fuel consumption of the engine 200 is minimal.

In contrast, if the sun gear 341 as one rotational element of the power dividing mechanism 300 is physically fixed by the clutch mechanism 350, the speed-change ratio of the power dividing mechanism 300 (i.e. a ratio of the combustion rotational speed NE of the engine 200 and the rotational speed Nout of the drive shaft 320 (hereinafter referred to as an “output rotational speed”, as occasion demands)) is fixed to one speed-change ratio, so that the fixed speed-change ratio is realized. More specifically, in the planetary gear mechanism, if the rotational speeds of two of the three elements, which are the sun gear, the carrier, and the ring gear, are determined, the rotational speed of the remaining one element is inevitably determined. In the second planetary gear mechanism 340, the output rotational speed Nout having a one-to-one relationship with the rotational speed of the carrier 342 is uniquely determined from the vehicle speed of the hybrid vehicle 10, and if the sun gear 341 is fixed and the rotational speed becomes zero, then the rotational speed of the ring gear 343 as one remaining element is inevitably determined. The ring gear 343 is connected to the carrier 332 of the first planetary gear mechanism 330 as described above, and the carrier 332 is connected to the input shaft 320, which is connected to the crankshaft 205 of the engine 200. Therefore, the combustion rotational speed NE of the engine 200 also inevitably has a one-to-one relationship with the rotational speed of the ring gear 343. In other words, in the fixed speed-change mode, the change characteristics of the combustion rotational speed NE of the engine 200 is uniquely determined in accordance with the vehicle speed V.

As described above, in the condition that the sun gear 341 is fixed by the clutch mechanism 350, a reaction element having the reaction torque of the engine torque in the power dividing mechanism 300 is transferred from the sun gear 331 (i.e. uniquely regarded as the motor generator MG1) to the sun gear 341 (i.e. uniquely regarded as the clutch mechanism 350), and only the second planetary gear mechanism 340 substantially contributes to the transmission of the engine torque to the drive shaft 320. Therefore, it is unnecessary to make the motor generator MG1 function as the electric generator and the electric motor, and there is no need to generate electricity on the motor generator MG2 and to feed it to the motor generator MG1, or to feed electricity from the battery 500 to the motor generator MG1. In other words, there is no electricity consumption; namely, in the fixed speed-change mode, there is no power loss caused by repeating the energy conversion between mechanical energy and electrical energy, i.e. power circulation, so that it is possible to prevent or limit or control poor fuel efficiency.

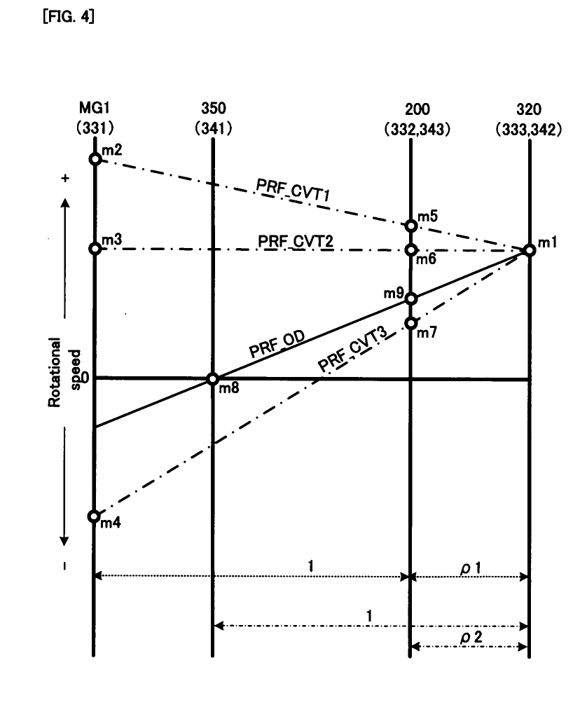

Now, with reference to FIG. 4, the stepless speed-change mode and the fixed speed-change mode will be further explained. FIG. 4 is a nomogram of the power dividing mechanism 300 corresponding to each speed-change mode. Incidentally, in FIG. 4, the repeated points of FIG. 1 will carry the same reference numerals, and the explanation thereof will be omitted as occasion demands.

In FIG. 4, from the left, the MG1 (i.e. uniquely regarded as the sun gear 331), the clutch mechanism 350 (i.e. uniquely regarded as the sun gear 341), the engine (i.e. uniquely regarded as the carrier 332 and the ring gear 343), and the drive shaft 320 (i.e. uniquely regarded as the carrier 333 and the ring gear 342) are shown in this order, and the rotational speeds thereof are shown on the vertical axis. Incidentally, it is assumed that the MG2 speed-change part 360 is fixed to one speed-change ratio.

Characteristic lines for illustrating the respective rotational speeds according to the stepless speed-change mode are shown as illustrated PRF_CVTn (n=1, 2, 3) (refer to chain lines). In the stepless speed-change mode, the combustion rotational speed NE of the engine 200 can be continuously controlled by increasing or decreasing the rotational speed of the motor generator MG1. For example, when the output rotational speed Nout (i.e. uniquely regarded as the rotational speed of the drive shaft; namely, uniquely regarded as the vehicle speed) is a white circuit ml illustrated, for example, if the rotational speed Nmg1 of the MG1 is sequentially changed to illustrated open circles m2, m3, and m4, the combustion rotational speed NE is sequentially changed to illustrated open circles m5, m6, and m7, which are a higher value, an equal value, and a lower value than the output rotational speed Nout, respectively.

Here, the characteristic illustrated in PRFCVT3 corresponds to a so-called overdrive state, in which the combustion rotational speed NE is lower than the output rotational speed Nout. If the overdrive state is realized in the stepless speed-change mode, the motor generator MG1 outputs the reaction torque (negative torque) of the engine torque in a negative rotation area, and the driving state thereof becomes a power-running state. On the other hand, on the motor generator MG2, in order to supply electricity to the MG1 in the power-running state (or to absorb the driving force outputted to the drive shaft 320 by power-running the MG1), the negative torque is outputted in a positive rotation area, and electricity is generated. As a result, if it is tried to realize the overdrive state in the stepless speed-change mode, the energy loss by the power circulation is hardly avoided depending on circumstances (in particular, in a high-rotation, light-load area).

On the other hand, in the condition that the clutch plates 351 and 352 of the clutch mechanism 350 engage with each other, the rotational speed of the clutch mechanism 350 is zero (refer to a open circle m8 illustrated), and the characteristic of the rotational speed of the power dividing mechanism 300 is in the state illustrated by PRF_OF (refer to a slid line). In other words, the combustion rotational speed NE of the engine 200 is fixed to a lower value than the output rotational speed Nout (refer to a open circle m9 illustrated). In other words, the overdrive state is realized. In this state, the reaction torque is applied to the sun gear 341 from the clutch mechanism 350, and the sun gear 341 function as a reactive element. Thus, it is unnecessary to make the motor generator MG1 function as either the electric generator or the electric motor, and the motor generator MG1 is substantially idling. Thus, it is unnecessary to supply electricity to the motor generator MG1 from the motor generator MG2, and the power circulation can be avoided.

The speed-change mode of the hybrid vehicle 10 is normally determined to be one of the two types of speed-change modes that provides better fuel consumption (i.e. highly efficient), depending on an operational condition required for the hybrid vehicle 10 at that time or an actual operational condition or the like of the hybrid vehicle 10. For example, the overdrive state by the fixed speed-change mode is realized in high-speed, light-load travelling such as high-speed, steady travelling in which the operating point of the engine 200 is hardly set on the optimum fuel consumption line.

The speed-change modes are changed by the ECU 100, as occasion demands.

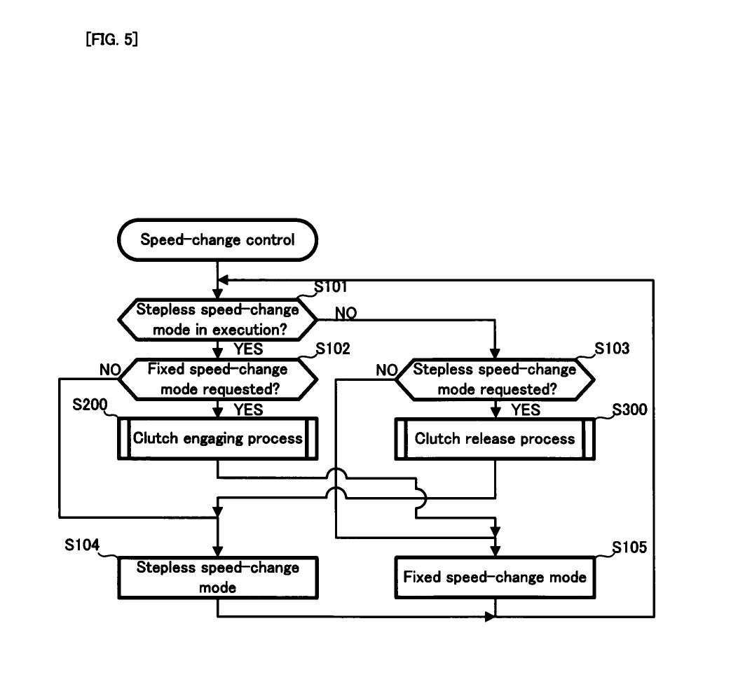

Now, with reference to FIG. 5, the details of the speed-change control will be explained. FIG. 5 is a flowchart showing speed-change control.

In FIG. 5, the ECU 100 judges or determines whether or not the stepless speed-change mode is selected (step S101). If the stepless speed-change mode is selected (the step S101: YES), the ECU 100 judges whether or not there is a request to change to the fixed speed-change mode (step S102). Here, the presence or absence of the request to change from the stepless speed-change mode to the fixed speed-change mode is judged on the basis of the vehicle speed V detected by the vehicle speed sensor 600 and the accelerator opening degree detected by an accelerator opening degree sensor not illustrated in FIG. 1. More specifically, the ECU 100 selects the fixed speed-change mode if the combination of the vehicle speed V and the accelerator opening degree corresponds to a predetermined high-speed, light-load area, which is set as providing the aforementioned power circulation. That is, the change request in the step S102 is unconditionally provided without a driver's will if the operating condition of the hybrid vehicle 10 satisfies a predetermined condition. However, if a driver requests this type of change to the fixed speed-change mode through some operating device, the judgment process may be performed on the basis of the presence or absence of a signal which is outputted from the operating device and which indicates that the driver requests the fixed speed-change mode.

If there is the request to change to the fixed speed-change mode (the step S102: YES), the ECU 100 performs a clutch engaging process described later (step S200). If the clutch engaging process is performed or if the fixed speed-change mode is not requested (the step S102: NO), the ECU 100 continues travel control by the stepless speed-change mode (step S104) and returns the process into the step S101 to repeat the series of processes.

On the other hand, in the process in the step S101, if the stepless speed-change mode is not selected, i.e. if travel control by the fixed speed-change mode is performed (the step S101: NO), the ECU 100 judges whether or not there is a request to change to the stepless speed-change mode (step S103). The judgment process in the step S103 is performed on the basis of the vehicle speed V and the accelerator opening degree, as in the process in the step S102.

If there is the request to change to the stepless speed-change mode (the step S103: YES), the ECU 100 performs a clutch release process described later (step S300). If the clutch release process is performed or if the stepless speed-change mode is not requested (the step S103: NO), the ECU 100 continues the travel control by the fixed speed-change mode (step S105) and returns the process into the step S101 to repeat the series of processes. The speed-change control is repeatedly performed by the ECU 100 with a predetermined period.

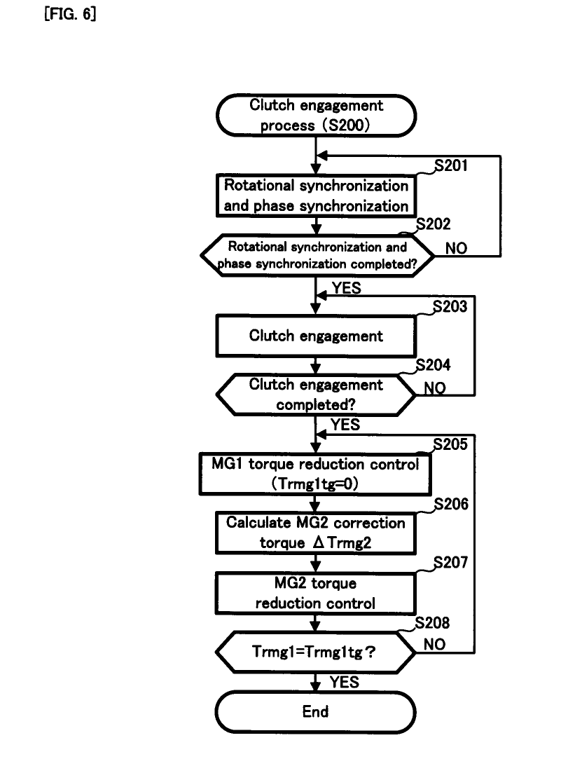

Next, with reference to FIG. 6, an explanation will be given on the details of the clutch engaging process in the step S200 in FIG. 5. FIG. 6 is a flowchart showing the clutch engaging process.

In FIG. 6, firstly, rotational synchronization and phase synchronization are performed in the clutch mechanism 350 (step S201).

Here, the “rotational synchronization” indicates the synchronization of the rotational speed between the clutch plates 351 and 352.

In this embodiment, the clutch plate 352, which is the engagement target of the clutch plate 351, is a so-called physically fixed brake, so that the rotational speed thereof is zero. Therefore, the ECU 100 controls the rotational speed of the motor generator MG1 such that the rotational speed of the clutch plate 351 is zero. The target value of the rotational speed of the motor generator MG1 at this time is calculated as the value that is uniquely determined in accordance with the output rotational speed Nout on the basis of the speed-change ratio of the sun gear 331, the sun gear 341, the carrier 332 (or the ring gear 343), and the ring gear 342 (or the carrier 333).

On the other hand, the phase synchronization is a process derived from the fact that the engaging device of the present invention is the dog clutch, and it is a process of accommodating the phases of the dog teeth formed on the engagement surface between the clutch plates 351 and 352, at a position at which the clutch plates can engage or interlock with each other. At this time, the clutch plate 352 is physically stopped, and information on the engageable position is provided in advance for the ECU 100. The ECU 100 refers to the rotation angle of the cutch plate 351 detected by the resolver provided for the clutch mechanism 350 and controls a driving circuit provided for the clutch mechanism such that the rotation angle of the clutch late 351 has a predetermined value. The rotational synchronization and the phase synchronization are performed in this manner. Incidentally, the implementation aspect of the rotational synchronization and the phase synchronization shown here is merely one example, and various known aspects may be used. Moreover, in accordance therewith, the structure of the clutch mechanism 350 may be changed, as occasion demands. During the rotational synchronization and the phase synchronization, it is judged whether or not the rotational synchronization and the phase synchronization are completed with a constant period (step S202). If the rotational synchronization and the phase synchronization are uncompleted (the step S202: NO), the process is returned to the step 5201 to repeat the series of processes. When the rotational synchronization and the phase synchronization are completed in the clutch mechanism 350, the ECU 100 makes the clutch mechanism 350 engage. In other words, the ECU 100 controls the driving circuit such that the clutch plate 351 is stroked by a predetermined amount in the direction of the clutch plate 352, which enables the both dog teeth to interlock with each other.

During the clutch engaging process of the clutch mechanism 350, it is judged whether or not the engagement of the clutch mechanism 350 is completed with a constant period (step S204). If the engagement of the clutch mechanism 350 is uncompleted (the step S204: NO), the clutch engaging process of the clutch mechanism 350 is continued. If the engagement of the clutch mechanism 350 is completed (the step S204: YES), a reaction-element changing process is started; namely, the reaction torque of the engine torque starts to be delivered from the sun gear 331, which is connected to the motor generator MG1, to the sun gear 341, which is connected to the clutch plate 351.

In the reaction-element changing process, output torque Trmg1 of the motor generator MG1 is gradually reduced, with target torque Trmg1tg being zero (step S205). More specifically, the ECU 100 reduces previously indicated torque value by a predetermined change amount in each predetermined processing cycle, to thereby set provisional indicated torque and gradually reduce the output torque Trmg1 of the motor generator MG1 through the control of the PCU 400. The predetermined change amount will be described later. Incidentally, the “predetermined change amount” is one example of the “degree of reduction” of the present invention.

If the gradual reduction of the output torque Trmg1 of the motor generator MG1 is started, the ECU 100 calculates correction torque ΔTrmg2, which is the correction value of output torque Trmg2 of the motor generator MG2 (step S206), determines a new indicated value by reducing the correction torque ΔTrmg2 from the previous indicated value of the output torque Trmg2, and reduces the output torque Trmg2 of the motor generator MG2 (step S207). Incidentally, the reduction control of the output torque Trmg2 of the motor generator MG2 will be described later.

If the reduction control of the output torque Trmg2 of the motor generator MG2 is performed, the ECU 100 judges whether or not the output torque Trmg1 of the motor generator MG1 has reached the target torque Trmg1tg (i.e. zero) (step S208). If the output torque Trmg1 is different from Trmg1tg (the step S208: NO), the process is returned to the step S205 to repeat the series of processes. If the output torque Trmg1 becomes equal to the target value Trmg1tg (the step S208: YES), the clutch engaging process is ended.

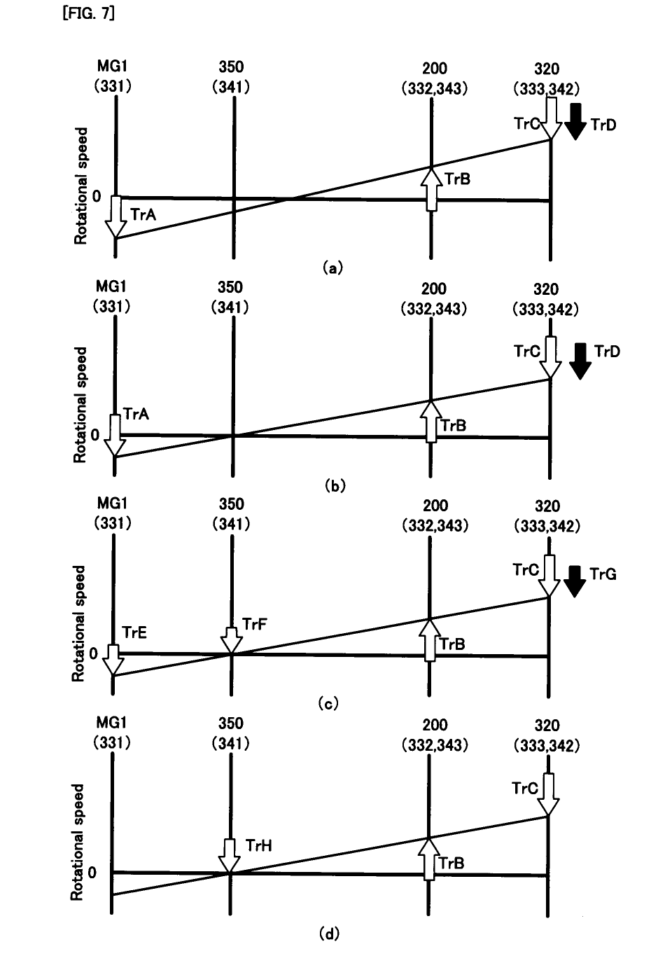

Now, with reference to FIG. 7, the input/output state of the torque in the power dividing mechanism 300 in the course of the clutch engaging process. FIG. 7 are nomograms of the power dividing mechanism 300 in the course of the clutch engaging process in FIG. 6. Incidentally, in FIG. 7, the repeated points of FIG. 4 will carry the same reference numerals, and the explanation thereof will be omitted as occasion demands.

FIG. 7 show a progression of the change of the reaction element, in order, from the top.

At the time point that the request to change from the stepless speed-change mode to the fixed speed-change mode is generated (i.e. at the time point that the process in the step S102 is branched to the “YES” side in FIG. 5), the reaction element in the power dividing mechanism 300 is still the motor generator MG1 (i.e. uniquely, the sun gear 331), and the reaction torque corresponding to torque TrB outputted from the engine 200 (i.e. uniquely, the carrier 332 and the ring gear 343) is outputted from the motor generator MG1 as torque TrA. On the other hand, torque TrC is inputted to the drive shaft 320 (i.e. uniquely, the ring gear 333 and the carrier 342) from the external world. At this time, the motor generator MG1 is in the power-running state. Thus, the motor generator MG1 outputs the torque to the drive shaft 320 with power consumption. On the motor generator MG2, electricity is generated to compensate for the power consumption. The output torque of the motor generator MG2 required for the generation of electricity is TrD illustrated in the drawing (FIG. 7(a)).

The rotational synchronization and the phase synchronization described above are performed from this state, and at the time point that the clutch mechanism 350 is engaged (i.e. at the time point that the process in the step S204 is branched to the “YES” side in FIG. 6), the rotational speed of the clutch mechanism 350 becomes zero without a change in the input/output relation of the torque, and the combustion rotational speed NE of the engine 200 is fixed to a rotational speed that is uniquely defined by the output rotational speed Nout and the rotational speed of the clutch mechanism 350 (FIG. 7(b)).

If the change of the reaction element is started from this state, then, for example, the output torque TrA of the motor generator MG1 is gradually reduced to TrE illustrated in the drawing. Along with this, the gradually-reduced reaction torque is received by the clutch mechanism 350, and torque TrF is generated in the clutch mechanism 350. At this time, there is no change in the output torque of the engine 200 and the torque inputted to the drive shaft 320, while the power consumption in the motor generator MG1 is reduced with the gradual reduction in the output torque of the motor generator MG1. Thus, it gradually becomes unnecessary to generate electricity in the motor generator MG2, and the output torque of the motor generator MG2 is reduced. In other words, as the power-running electric power of the motor generator MG1 is gradually reduced, the torque outputted to the drive shaft 320 is reduced, so that there arises a need to reduce the output torque of the motor generator MG2 which acts as a so-called braking force because of the action which generates electrical power. As a result, the output torque of the motor generator MG2 is reduced to TrG (FIG. 7(c)).

As a result of the progression of the change of the reaction element, if the reaction element is transferred from the motor generator MG1 to the clutch mechanism 350, the motor generator MG1 becomes in such a state that it does not generate electricity nor perform the power-running, i.e. in a so-called idling state. Moreover, the reaction torque of the output torque TrB of the engine 200, which is torque TrH, is outputted from the clutch mechanism 350. At this time, the output torque of the motor generator MG2 becomes zero in response to the output of the motor generator MG1 of zero (FIG. 7(d)). In other words, in this state, the hybrid vehicle 10 performs so-called engine running only by using the power of the engine 200.

Incidentally, in consideration of energy efficiency, it is appropriate that the torque of the motor generator MG1 is zero as shown by the drawings; however, the motor generator MG2 may continue a small amount of electricity-generating operation in some cases. In other words, in view of the balance of driving torque in the power dividing mechanism 300 (i.e. the balance between driving torque Tr applied to the drive shaft 320 upward (which is not illustrated but one example of the “output torque of the drive shaft” in the present invention) and the illustrated TrC acted from the external world), if the electricity-generating operation of the motor generator MG2 is needed to some extent, the electricity generation by the motor generator MG2 can be continued even after the transfer of the reaction torque.

Here, in the change process of the reaction element shown in FIG. 7(c), if the output torque of the motor generator MG1 is gradually reduced, the torque physically corresponding to the amount of the gradual reduction is transferred to the clutch mechanism 350. At this time, the value of the reaction torque shared by the clutch mechanism 350 corresponds to the amount of the gradual reduction in a one-to-one manner but is not necessarily identical with the amount of the gradual reduction in accordance with a gear ratio between the rotational elements of the power dividing mechanism 300. Therefore, if the gear ratio between the rotational elements of the power dividing mechanism 300 is not considered in the calculation of the aforementioned correction amount ΔTrmg2 associated with the output torque of the motor generator MG2, then, the output torque Tr of the drive shaft 320 (i.e. the output torque of the power dividing mechanism 300) varies to make the balance off with the torque TrC inputted from the external world, and this causes variations in the combustion rotational speed NE, variations in the vehicle speed V, physical vibration, or the like, which may result in the actualization of the deterioration of drivability.

Thus, in the process in the step S206 in FIG. 6, in order to limit or control the variations in the output torque of the drive shaft 320 after the following calculation process, the correction amount ΔTrmg2 of the output torque Trmg2 of the motor generator MG2 is calculated.

In other words, the output torque Tr of the drive shaft 320 before the change of the reaction element can be obtained as the following equation (1).

Tr=−1/ρ1×Trmg1′+Trmg2′ (1)

Here, explaining this with reference to FIG. 4, ρ1 is the gear ratio of the ring gear 333 (or the carrier 342) to the carrier 332 (or the ring gear 343) in a case where the gear ratio of the sun gear 331 to the carrier 332 (or the ring gear 343) is 1. Moreover, Trmg1′ is the value of the output torque of the motor generator MG1 before the change of the reaction element (i.e. the torque applied to the sun gear 331) Trmg1. Trmg2′ is the value of the output torque Trmg2 applied to the drive shaft 320 by the motor generator MG2 before the change of the reaction element.

On the other hand, the output torque Tr after the change of the reaction element is expressed by the following equation (2).

Tr=−(1−ρ2)/ρ2×Trc1+Trmg2″ (2)

Now, with reference to FIG. 4 again, ρ2 is the gear ratio of the carrier 332 (or the ring gear 343) to the ring gear 333 (or the carrier 342) in a case where the gear ratio of the sun gear 341 to the ring gear 333 (or the carrier 342) is 1. Moreover, Trc1 is the value of torque shared by the clutch mechanism 350 after the change of the reaction element. Trmg2″ is the value of the output torque Trmg2 applied to the drive shaft 320 by the motor generator MG2 after the change of the reaction element.

On the basis of the aforementioned equations (1) and (2), the aforementioned correction amount ΔTrmg2 is expressed by the following equation (3) as a function of a change amount ΔTrmg1 of the output torque of the motor generator MG1.

ΔTrmg2=(ρ2/ρ1−1+ρ2)×ΔTrmg1 (3)

During the change of the reaction element, in other words, during the gradual reduction in the output torque of the motor generator MG1 (i.e. one example of the “reduction period” of the present invention), it is possible to limit or control the variations in the output torque Tr of the drive shaft 320 by correcting the output torque Trmg2 of MG2 on the basis of the correction amount ΔTrmg2 derived in response to ΔTrmg1 in accordance with the aforementioned equation (3).

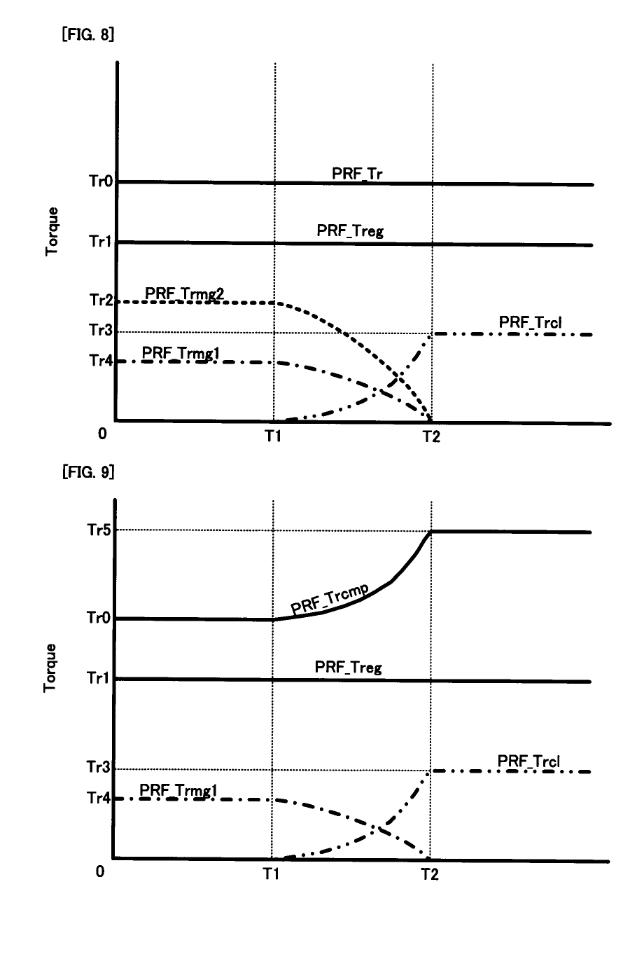

Next, with reference to FIG. 8, an effect in the embodiment will be visually explained. FIG. 8 is a time chart showing torque in each element in the course of the clutch engaging process in FIG. 6.

In FIG. 8, a period before a time point T1 is such a period that the sun gear 331 joined to the motor generator MG1 is the reaction element. A period after a time point T2 is such a period that the sun gear 341 joined to the clutch plate 351 is the reaction element. A period from the time point T1 to the time point T2 is the aforementioned change period of the reaction element; namely, it corresponds to one example of the “reduction period” of the present invention.

In FIG. 8, the property of the output torque of the engine 200 is constant at Tr1, as expressed as PRF_Treg (refer to a solid line). On the one hand, the output torque Trmg1 of the motor generator MG1 is Tr4 before the time point T1, and after the time point T1, it is gradually reduced to zero at the time point T2 (refer to PRF_Trgm1 (an alternate long and short dash line) in FIG. 8). On the other hand, with the gradual reduction in Trmg1, the reaction element is physically transferred to the sun gear 341, and the output torque Trcl of the clutch mechanism 350 gradually increases from zero at the time point T1 to Tr3 at the time point T2 (Tr3>Tr4) (refer to PRF_Trcl (an alternate long and two short dash line) in FIG. 8). In contrast, the output torque Trmg2 of the motor generator MG2 (refer to PRF_Trmg2 (a dashed line) in FIG. 8) reduces from Tr2 at the time point T1, by the correction amount ΔTrmg2 calculated from the aforementioned equation (3) in accordance with ΔTrmg1 corresponding to the amount of the gradual reduction in Trmg1, and it becomes zero at the time point T2 with time.

Here, the gear ratio between the rotational elements of the power dividing mechanism 300 is considered for the correction amount ΔTrmg2, and its value is determined such that the variations in the output torque Tr of the drive shaft 320 are zero when the reaction element is transferred from the sun gear 331 to the sun gear 341. Therefore, in the change period of the reaction element from the time points T1 to T2, the output torque Tr of the drive shaft 320 does not vary and remains constant at Tr0, as shown by PRF_Tr (refer to a solid line) in FIG. 8.

As described above, according to the clutch engaging process in the embodiment, the clutch mechanism 350 is already engaged before the change of the reaction element is started. Thus, in the change period of the reaction element, it is possible to limit or control the variations in the output torque of the drive shaft 320 only by the torque control of the motor generator MG1 and the motor generator MG2. In other words, when the variations in the output torque of the drive shaft 320 are limited or controlled, there is no need to actively control the engagement torque of the clutch mechanism 350. The motor generator can perform at least the accurate torque control based on indicated torque, in comparison with the control of the engagement torque in the engaging device which is substantially hardly estimated. It is clearly effective in comparison with a case where the engagement torque is used to limit or control the variations in the output torque of the drive shaft 320.

Moreover, according to the engagement control in the embodiment, the rotational synchronization and the phase synchronization (the phase synchronization is caused by that the clutch mechanism 350 is a dog clutch) are performed when the clutch plates 351 and 352 are engaged with each other, so that a practically-perceivable-degree of torque variation does not occur even when the clutch mechanism 350 is engaged. In other words, according to the clutch engaging process in the embodiment, the variations in the output torque of the drive shaft 320 is preferably limited or controlled during the change of the speed-change mode from the stepless speed-change mode to the fixed speed-change mode.

Incidentally, at this time, the torque control accuracy and the torque response speed of the motor generator MG2 used to limit or control the variations in the output torque may be ensured equally to or more than equally to those of the motor generator MG1.

Moreover, explaining this with reference to FIG. 8, the change amount associated with the gradual reduction of the output torque Trmg1 of the motor generator MG1 (i.e. ΔTrmg1) is set variable in accordance with an elapsed time from the start time point of the change of the reaction element. As is clear with reference to PRF_Trmg1 illustrated, the reduction amount of the output torque Trmg1 in one control period is set smaller as the elapsed time is shorter. Therefore, the reaction torque transferred to the clutch mechanism 350 also becomes the smallest near the rising in the vicinity of the time point T1.

The clutch mechanism 350 adopts a dog clutch as its engagement element, and the engagement is accompanied by the interlock between the clutch plate 351 and the clutch plate 352. As described above, in the interlock, the phase synchronization is performed, and strokes are performed by the driving apparatus in such a state that the dog teeth of the both clutch plates are preferably interlocked (in other words, otherwise, stroke failures will occur). Here, if the dog teeth of the both clutch plates are merely interlocked but torque is not applied thereto, they are in a so-called “floating” state even in their interlock. The engagement torque is generated by the clutch plate 352 preventing the clutch plate 351 from rotating in a predetermined direction with the transfer of the reaction torque. Therefore, at the start time point of the generation of the engagement torque, as relatively higher torque is generated, the degree of physical impact, such as chatter or rattle, caused by the physical collision between the dog teeth becomes stronger, which causes the deterioration of a NV (Noise and Vibration) performance. Moreover, it likely has an adverse effect on the physical durability of the clutch mechanism 350.

Thus, in the embodiment, at the beginning of the change of the reaction element, the torque to be transferred is set relatively small, and after torque is properly applied between the clutch plates, the torque to be transferred is increased. This is how to change the reaction element as quickly as possible while maintaining the NV performance.

Incidentally, in the embodiment, the reduction amount of the output torque of MG1 is increased continuously in accordance with the elapsed time. However, of course, as long as the aforementioned NV performance and durability performance can be included in an acceptable range at least in practice, the reduction amount of the output torque of MG1 may be stepwise, and in an extreme case, the reduction amount may be reduced in a binary manner only at the beginning of the change period of the reaction element. In other words, the expression that “such that . . . is small with respect to at least one portion excluding a beginning at least at the beginning of the reduction period” in the present invention is a wide concept including such a binary, stepwise, or continuous change.

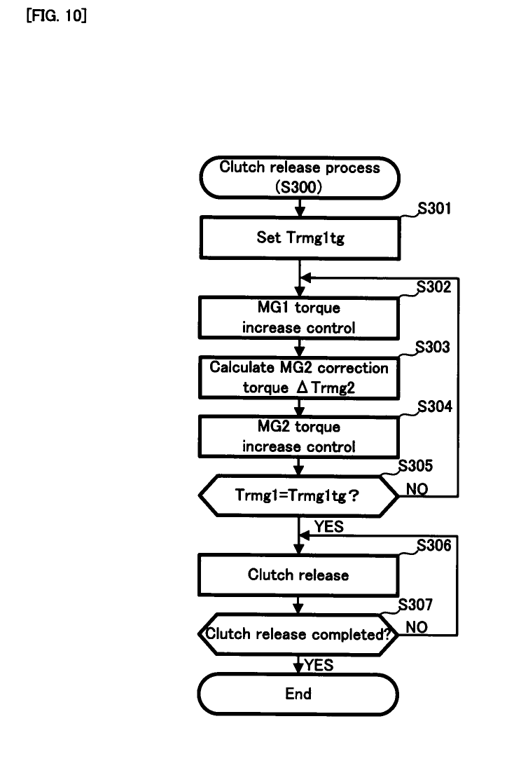

Now, with reference to FIG. 9, the effect in the embodiment will be explained by using a comparative example in order to clarify the effect. FIG. 9 is a time chart showing the torque in each element in the course of a clutch engaging process in the comparative example. Incidentally, in FIG. 9, the repeated points of FIG. 8 will carry the same reference numerals, and the explanation thereof will be omitted as occasion demands.

In FIG. 9, the comparative example is expressed as a property corresponding to a case where the gear ratio between the rotational elements of the power dividing mechanism is not considered when the output torque Trmg2 of the motor generator MG2 (not illustrated in FIG. 9) is reduced in the change period of the reaction element. In other words, in this case, as shown as PRF_Trcmp (refer to a solid line) in FIG. 9, when the reaction element is changed from the time point T1 to the time point T2, the output torque of the drive shaft 320 is increased in accordance with the transfer of the torque to the clutch mechanism 350, thereby generating the variations in the output torque. The variations in the output torque are accompanied by the variations in the vehicle speed V, the variations in the combustion rotational speed NE, or the physical vibration, and thus, they deteriorate the drivability. The embodiment is clearly more advantageous than the comparative example in that the variations in the output torque of the drive shaft 320 are limited or controlled.

The control of the output torque of the motor generator MG2 considering the properties of the rotational elements of the power dividing mechanism 300 is effective even in the change from the fixed speed-change mode to the stepless speed-change mode. Now, with reference to FIG. 10, the details of the clutch release process in the step S300 will be explained. FIG. 10 is a flowchart showing the clutch release process.

In FIG. 10, the ECU 100 sets the target torque Trmg1tg of the motor generator MG1 (step S301). After setting the target torque, the ECU 100 gradually increases the output torque of the motor generator MG1 (step S302). At this time, as opposed to the clutch engaging process, the change amount ΔTrmg1 of the output torque Trmg1 is gradually reduced in accordance with the elapsed time.

Moreover, in the gradual increase in the output torque Trmg1, as opposed to the clutch engaging process, the change amount ΔTrmg1 is set relatively large at the beginning of the change period of the reaction element. This is because the physical impact, such as chatter or rattle, is easily generated at the end of the change period in the release of the clutch mechanism 350, as opposed to in the engagement.

If the gradual increase in the output torque of MG1 is controlled, the ECU 100 calculates the correction amount ΔTrmg2 of the output torque Trmg2 of the motor generator MG2 such that the variations in the output torque of the drive shaft 320 generated in accordance with the change of the reaction element from the sun gear 341 to the sun gear 331 are limited or controlled, on the basis of the aforementioned equation (3) (step S303), and corrects the torque indicated value in accordance with the correction amount, thereby controlling the output torque Trmg2 of MG2 (step S304).

In the course of the gradual increase in the output torque Trmg2 of MG2 accompanied by the gradual increase in the output torque Trmg1 of MG1, it is judged whether or not the output torque Trmg1 of MG1 is identical with the target torque Trmg1tg set in the process in the step S301 (step S305). If not (the step S305: NO), the process is returned to the step S302 and the series of processes is repeated. If Trmg1 is identical with the target value Trmg1tg (the step S305: YES), the clutch mechanism 305 is released (step S306), and it is judged whether or not the release of the clutch mechanism 350 is completed (step S307). If the release of the clutch mechanism 350 is uncompleted (the step S307: NO), the release of the clutch mechanism 350 is continued. If the release of the clutch mechanism 350 is completed (the step S307: YES), the clutch release process is ended. Incidentally, in the release of the clutch mechanism 350, unlike in the engagement, the rotational synchronization and the phase synchronization are not required. The ECU 100 controls the driving apparatus to stroke the clutch plate 351 in an opposite direction of the clutch plate 352, thereby releasing the interlock between the dog teeth.

As described above, even in the clutch release process, the correction amount ΔTrmg2 of the output torque Trmg2 of the motor generator MG2, which does not cause the variations in the output torque in the drive shaft 320, is calculated in accordance with the sharing rate of the reaction torque (i.e. in accordance with the change amount ΔTrmg1 of the output torque of the motor generator MG1), and it is used for the control of the output torque Trmg2. Therefore, in the change of the speed-change mode from the fixed speed-change mode to the stepless speed-change mode, it is possible to limit or control the variations in the output torque of the drive shaft 320.

As explained above, according to the speed-change control in the embodiment, there are no variations in the output torque of the drive shaft 320 in both the change period from the stepless speed-change mode to the fixed speed-change mode (or overdrive mode) and the change period from the fixed speed-change mode (or overdrive mode) to the stepless speed-change mode. In other words, the change of the speed-change mode is preferably realized.

### Drive Shaft <Second Embodiment>

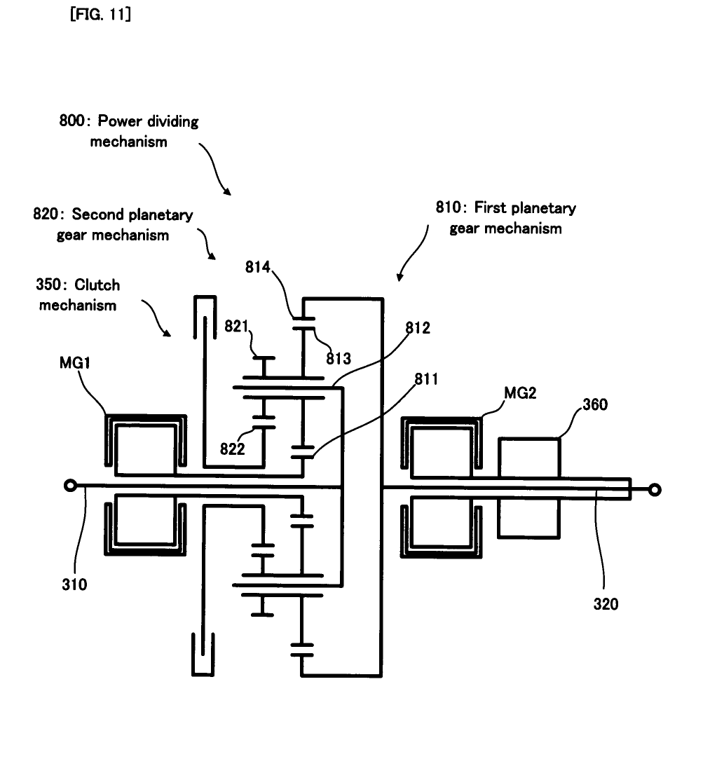

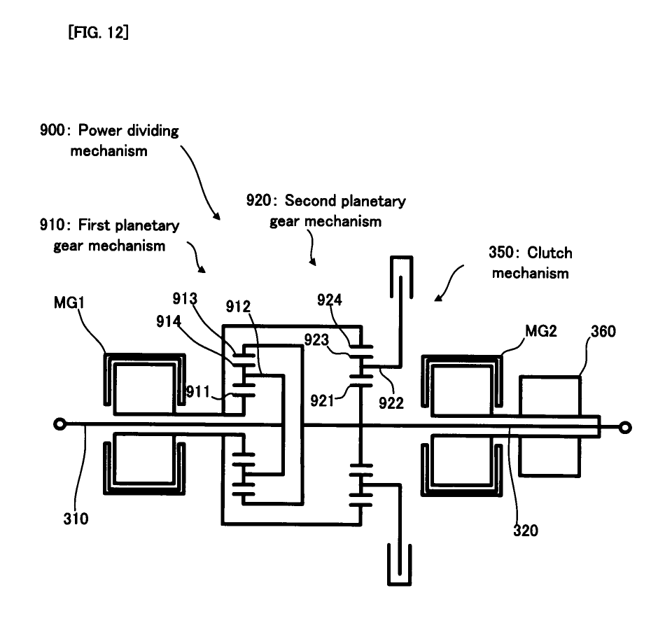

As one example of the “power dividing device” of the present invention, the first embodiment illustrates the power dividing mechanism 300 obtained by combining the single pinion type planetary gear mechanism and the double pinion type planetary gear mechanism; however, the construction that the power dividing device of the present invention can adopt is not limited to the power dividing mechanism 300 as long as it can realize at least the stepless speed-change mode and the fixed speed-change mode. Now, with reference to FIG. 11 and FIG. 12, other construction examples of the power dividing device will be explained as a second embodiment of the present invention. FIG. 11 is a schematic configuration diagram conceptually showing the structure of a power dividing mechanism 800. FIG. 12 is a schematic configuration diagram conceptually showing the structure of a power dividing mechanism 900. Incidentally, in FIG. 11 and FIG. 12, the repeated points of FIG. 3 will carry the same reference numerals, and the explanation thereof will be omitted as occasion demands.

In FIG. 11, in the power dividing mechanism 800, the input shaft 310 connected to the crankshaft 205 of the engine 200 is connected to a carrier 812. The motor generator MG1 is connected to a sun gear 811, and a ring gear 814 as an internal gear, placed concentrically to the sun gear 811, is connected to the drive shaft 320. A large pinion gear 813 which engages or interlocks with the sun gear 811 and the ring gear 814 is held by the carrier 812 so as to rotate around its central axis and to revolve because of the rotation of the carrier 812. The carrier 812, the sun gear 811, the ring gear 814, and the large pinion gear 813 constitute a first planetary gear mechanism 810.

On the other hand, the large pinion gear 813 is constructed as a so-called stepped pinion gear; namely, a small pinion gear 821 with a smaller diameter than that of the large pinion gear 813 is arranged in the same axis and integrated with the large pinion gear 813. The small pinion gear 821 engages or interlocks with a sun gear 822 with a larger diameter than that of the sun gear 811. In other words, the sun gear 822, the large pinion gear 813 and the small pinion gear 821 (i.e. the stepped pinion gear), and the carrier 812 for holding the pinion gear, and the aforementioned ring gear 814 constitutes a second planetary gear mechanism 820. As described above, the power dividing mechanism 800 is provided with the two pairs of planetary gear mechanisms, which share the carrier and the ring gear by integrally connecting the pinion gears with different number of teeth.

Therefore, the sun gear 811 in the first planetary gear mechanism 810 has a smaller diameter than that of the sun gear 822 in the second planetary gear mechanism 820, and the ring gear 814 is shared, so that the gear ratio of the first planetary gear mechanism 810 (or a ratio of the number of teeth between sun gear and the ring gear) is less than the gear ratio of the second planetary gear mechanism 820. Here, the aforementioned clutch mechanism 350 is connected to the sun gear 822, wherein the clutch mechanism 350 selectively stops the rotation of the sun gear 822. If the clutch mechanism 350 is in the engagement state, the sun gear 822 is physically fixed, so that the speed-change ratio of the power dividing mechanism 300 becomes the overdrive speed-change ratio.

In FIG. 12, the power dividing mechanism 900 is provided with a first planetary gear mechanism 910 and a second planetary gear mechanism 920. The input shaft 310 for transmitting the engine torque is connected to a carrier 912 of the first planetary gear mechanism 910. The motor generator MG1 is connected to a sun gear 911 of the first planetary gear mechanism 910, and a ring gear 913 as an internal gear, placed concentrically to the sun gear 911, is connected to the drive shaft 320. A pinion gear 914 which engages or interlocks with the sun gear 911 and the ring gear 913 is held by the carrier 912 so as to rotate around its central axis and to revolve because of the rotation of the carrier 912.

The second planetary gear mechanism 920 is arranged on the same axis as that of the first planetary gear mechanism 910. The drive shaft 320 passes through the central portion of a sun gear 921, and the sun gear 921 is connected to the drive shaft 320. In other words, the sun gear 921 is connected to the ring gear 913 of the first planetary gear mechanism 910 to integrally rotate. Moreover, a ring gear 924 placed concentrically to the sun gear 921 is connected to the sun gear 911 of the first planetary gear mechanism 910. In other words, the ring gear 924 of the second planetary gear mechanism 920 is connected to the motor generator MG1.

Moreover, a pinion gear 923 which is located between and engages or interlocks with the sun gear 921 and the ring gear 924 is held by the carrier 922 so as to rotate and revolve. The clutch mechanism 350 is placed so as to selectively fix the carrier 922. As described above, the power dividing mechanism 900 is provided with the two pairs of single pinion type planetary gear mechanisms. Even in such construction, it is possible to preferably realize the stepless speed-change mode and the fixed speed-change mode by controlling the clutch mechanism 350 to be in the engagement state.

Here, if the power dividing mechanisms 800 and 900 are used, it is possible to determine the correction amount of the output torque of the motor generator MG2 with respect to the change amount of the output torque of the motor generator MG1, which can limit or control the variations in the output torque generated in the drive shaft 320, as in the first embodiment, on the basis of the gear ratio between the rotational elements of each of the power dividing mechanisms, although the structure of the correction formula corresponding to the aforementioned equation (3) is different. It is also possible to preferably limit or control the variations in the output torque of the drive shaft 320 in the change period of the speed-change mode, as in the first embodiment.

The present invention is not limited to the aforementioned embodiments, but various changes may be made, if desired, without departing from the essence or spirit of the invention which can be read from the claims and the entire specification. A control apparatus for a hybrid driving apparatus, which involves such changes, is also intended to be within the technical scope of the present invention.

### INDUSTRIAL APPLICABILITY

The present invention can be applied to a hybrid driving apparatus which has an internal combustion engine and an electric motor as a power source and which is provided with a plurality of speed-change modes.

1. A control apparatus for a hybrid driving apparatus installed in a vehicle, said hybrid driving apparatus comprising:
an internal combustion engine;
a first electric motor;
an engaging device comprising first and second engagement elements which can engage with each other;
a power dividing device comprising a plurality of rotational elements including a first rotational element connected to an output shaft of the internal combustion engine, a second rotational element connected to an output shaft of said first electric motor, a third rotational element connected to a drive shaft of the vehicle, and a fourth rotational element connected to the first engagement element, the rotational elements being adapted to mutually perform differential rotation; and
a second electric motor whose output shaft is connected to the third rotational element,
said first electric motor capable of controlling rotational speeds of the first and fourth rotational elements,
said hybrid driving apparatus capable of realizing each of a stepless speed-change mode, which can continuously change a rotational speed ratio between the drive shaft and the output shaft of said internal combustion engine, and a fixed speed-change mode, which fixes the rotational speed ratio to a predetermined value, as a speed-change mode of the vehicle by that rotation of the first engagement element is stopped in such a state that the first engagement element and the second engagement element are engaged and by that the first engagement element and the second engagement element are separated and engaged,
said control apparatus comprising:
a first controlling device for controlling said engaging device such that the first engagement element and the second engagement element are engaged in a mutually rotational synchronization state, in response to a change request indicating that the speed-change mode is to be changed from the stepless speed-change mode to the fixed speed-change mode;
a second controlling device for reducing output torque of said first electric motor to predetermined target torque in the state that the first engagement element and the second engagement element are engaged with each other; and
a third controlling device for controlling said second electric motor such that variations in output torque of the drive shaft are limited or controlled in at least one portion of a reduction period in which output torque of said first electric motor is reduced.

2. The control apparatus for the hybrid driving apparatus according to claim 1, wherein
the predetermined value of the rotational speed ratio is an overdrive speed-change ratio corresponding to that a combustion rotational speed of the internal combustion engine is less than a rotational speed of the drive shaft, and
the target torque is zero.

3. The control apparatus for the hybrid driving apparatus according to claim 1 or 2, wherein said third controlling device controls said second electric motor in accordance with degree of the reduction in the output torque of said first electric motor.

4. The control apparatus for the hybrid driving apparatus according to claim 3, further comprising a calculating device for calculating a control amount of said second electric motor in the at least one portion of the reduction period on the basis of the degree of the reduction in the output torque of said first electric motor and a gear ratio among the first, second, third, and fourth rotational elements in said power dividing device,
said third controlling device controls said second electric motor in accordance with the calculated control amount.

5. The control apparatus for the hybrid driving apparatus according to any one of claims 1 to 4, wherein
the first and second engagement elements are engaged by interlocking with each other, and
said second controlling device controls said first electric motor such that the degree of the reduction in the output torque of the first electric motor is small with respect to at least one portion excluding a beginning at the beginning of the reduction period.
